(19) United States
(12) Patent Application Publication
(10) Pub. No.: US 2014/0101394 A1
(43) Pub. Date: Apr. 10, 2014

(54) COMPUTER SYSTEM AND VOLUME MANAGEMENT METHOD FOR THE COMPUTER SYSTEM

(71) Applicants: Abhishek Johri, Yokohama (JP); Yoshiaki Eguchi, Yokohama (JP); Hideo Saito, Kawasaki (JP)

(72) Inventors: Abhishek Johri, Yokohama (JP); Yoshiaki Eguchi, Yokohama (JP); Hideo Saito, Kawasaki (JP)

(73) Assignee: Hitachi, Ltd., Tokyo (JP)

(21) Appl. No.: 13/702,230

(22) PCT Filed: Oct. 4, 2012
(86) PCT No.: PCT/JP2012/006402

§ 371 Date: Dec. 5, 2012

(51) Int. Cl. G06F 12/00

(52) U.S. Cl. CPC G06F 12/00
USPC 711/154

(57) ABSTRACT

The present invention allows distribution of load generated by a single VOL to multiple processor units, by dividing the VOL into a plurality of smaller fractions called sub-VOL and distributing their ownership to multiple processor units. The division of a VOL is performed by dividing the control information of the VOL for plurality of sub-VOLs and (A) assigning VOL ownership to a processor unit for processing the tasks that are related to complete VOL (e.g. VOL RESERVE command) and (B) assigning ownership of each sub-VOL to different processor units for processing tasks that are specific to that sub-VOL (e.g. Read/Write commands). Thus the load on a singular sub-VOL owner processor unit becomes only a fraction of the total load generated by the VOL. The present invention helps in achieving a relatively even distribution of load among processor units.

### TECHNICAL FIELD

The present invention is generally related to a computer system and a volume management method for the computer system, and is related to, for example, a technique of load balancing among a plurality of processor units in a storage subsystem in the computer system.

### BACKGROUND ART

Patent Citations 1 and 2 disclose storage systems comprising plurality of processor units, respectively.

These storage systems manage a plurality of logical storage devices (hereinafter, “logical storage device” will be also referred to as “logical volume” or “VOL”), and for each VOL, grant ownership of the VOL to a single processor unit. As used here, “VOL ownership” is a right to access the VOL.

For example, it is supposed that the storage system has processor units #0 and #1, and manages VOL #0, #1 and #2, and that the storage system grants ownership of VOL #1 to processor unit #0. This storage system is such that when the storage system receives an I/O (Input/Output) command for VOL #1, the processor unit #0, which has the ownership of VOL #1, processes this I/O command.

Centralizing the ownership for a plurality of VOLs in one processor unit intensifies the load on this processor unit. According to Patent Citation 1, the storage system monitors the load on each processor unit, and changes the ownership among the processor units in accordance with the results of this monitoring.

According to Patent Citation 2, the storage system balances the load by changing the VOLs' owner rights (referred to as “ownership” also). A change in owner right of a VOL is carried out based on static information that does not dynamically change in accordance with the number of I/O commands related to a VOL.

### CITATION LIST

### Patent Literature

PTL 1: U.S. Pat. No. 7,912,996
PTL 2: US Publication 2010/0306465

### SUMMARY OF INVENTION

### Technical Problem

The storage systems disclosed in Patent Citations 1 and 2 assign ownership of an entire VOL to a single processor unit. Thus, a load caused by I/O processing for the VOL, to its owner processor unit, cannot be distributed to other processor units. The storage system can only change the ownership of this VOL to a different processor unit that has relatively lesser load.

This is, however, a problem for Big Data applications, which perform a large number of I/O operations on a single or a small number of larger VOLs. Even if a storage system has multiple processor units, the performance of such applications is limited by the performance of a single processor unit.

Not being able to distribute the load of a VOL is also a problem when the total number of VOLs in a storage system is relatively small. In this case, there is a probability that the accumulated load of all the processor units is not evenly distributed among the processor units, because of uneven load caused by each VOL. And since the total number of VOLs is very small, the uneven load distribution can not be leveled, even by changing the ownership of VOLs. This uneven distribution of load may cause performance loss of the storage system.

The present invention is made in view of such circumstances, and provides a technique that makes it possible to evenly distribute the loads of the processor units to utilize resources of the storage system efficiently.

### Solution to Problem

In order to solve the problems above, with the present invention, the present invention provides a computer system (storage system) comprising of a plurality of processor units. This storage system can treat a VOL as if it was made of multiple smaller VOLs (hereinafter, this smaller VOL (which is a fraction of a VOL), will also be referred to as “sub-volume” or “sub-VOL”. Plural: “sub-volumes” or “sub-VOLs”). The division of VOL in multiple sub-VOLs is performed by dividing the control information of the VOL for a plurality of sub-VOLs and using sub-VOL owner processor unit table and the sub-VOL control information tables in order to access the sub-VOL. Each processor unit has ownership of one or more VOLs and/or also has the right to process all I/O requests for one or more sub-VOLs (hereinafter, this right to process I/O for a sub-VOL will also be referred to as ownership of sub-VOL).

Thus, the present invention provides a computer system coupled to a computer comprising a storage subsystem including a plurality of storage devices providing at least one logical volume to the computer and a plurality of processor units each of which processes a command issued by the computer. At least one of the logical volumes is divided into a plurality of sub-volumes. A volume owner processor of the logical volume, which is responsible for processing I/O for the logical volume, is one of the plurality of processor unit, and a sub-volume owner processor for the at least one of the plurality of sub-volumes is one of the plurality of processor units which is not the volume owner processor of the logical volume.

### Advantageous Effects of Invention

According to the present invention, it becomes possible to evenly distribute the loads of the processor units to utilize resources of the storage system efficiently.

### BRIEF DESCRIPTION OF DRAWINGS

FIG. 1 shows structure of a storage system.

FIG. 2 shows an example of contents stored in cache memory package of the storage system according to the embodiment 1.

FIG. 3 shows an example of contents of memory in FE-PK according to the embodiment 1.

FIG. 4 shows an example of contents of Local Memory in MP-PK according to the embodiment 1.

FIG. 5 shows an example of VOL owner MP-PK table according to the embodiment 1.

FIG. 6 shows an example of Sub-VOL owner MP-PK table according to the embodiment 1.

FIG. 7 shows an example of VOL control information table according to the embodiment 1.

FIG. 8 shows an example of Sub-VOL control information table according to the embodiment 1.

FIG. 9 shows a flowchart of VOL creation program according to the embodiment 1.

FIG. 10 shows a flowchart of Local Router processing program according to the embodiment 1.

FIG. 11 shows a flowchart of Read command processing program according to the embodiment 1.

FIG. 12 shows a flowchart of Write command processing program according to the embodiment 1.

FIG. 13 shows a flowchart of Reserve/Release command processing program according to the embodiment 1.

FIG. 14 shows an example of contents of memory in FE-PK according to the embodiment 2.

FIG. 15 shows an example of contents of Local Memory in MP-PK according to the embodiment 2.

FIG. 16 shows an example of VOL pair information table according to the embodiment 2.

FIG. 17 shows an example of Sub-VOL pair information table according to the embodiment 2.

FIG. 18 shows a flowchart of pair creation program according to the embodiment 2.

FIG. 19 shows a flowchart of pair operation (pair split/pair resync) for VOL owner MP-PK according to the embodiment 2.

FIG. 20 shows a flowchart of pair operation (pair split/pair resync/pair create) for Sub-VOL owner MP-PK.

FIG. 21 shows a flowchart of PVOL Write operation according to the embodiment 2.

FIG. 22 shows an example of contents of Local Memory in MP-PK according to the embodiment 3.

FIG. 23 shows an example of Sub-VOL pair information table according to the embodiment 3.

FIG. 24 shows an example of LBA data pointer table according to the embodiment 3.

FIG. 25 shows a flowchart of PVOL/SVOL READ operation according to the embodiment 3.

FIG. 26 shows a flowchart of PVOL WRITE operation according to the embodiment 3.

### DESCRIPTION OF EMBODIMENTS

Embodiments of the present invention are described below with reference to the accompanying drawings. In the accompanying drawings, elements with like functions may sometimes be designated with like reference numerals.

It is noted that, in the following description, various types of information of the present invention are described in “table” format. However, such information need not necessarily be expressed through a table-based data structure, and may instead be expressed through such data structures as lists, DBs, queues, etc., or in some other manner. Accordingly, in order to illustrate the fact that they are not dependent on data structure, “tables,” “lists,” “DBs,” “queues,” etc., may sometimes be referred to simply as “information.”

Further, in describing the contents of various information, such expressions as “identification information,” “identifier,” “name,” “appellation,” and “ID” may be used, and they may be used interchangeably.

Descriptions are provided below with respect to various processes in the embodiments of the present invention, assuming a “program” as the subject (operating body) of the sentence. However, since programs perform prescribed processes using memory and communications ports (communications controllers) by being executed by a processor unit or multiple processor units, the descriptions may be construed with the subject of the sentence being a processor unit or processor units.

### (1) Embodiment 1

### <Configuration of a Computer System>

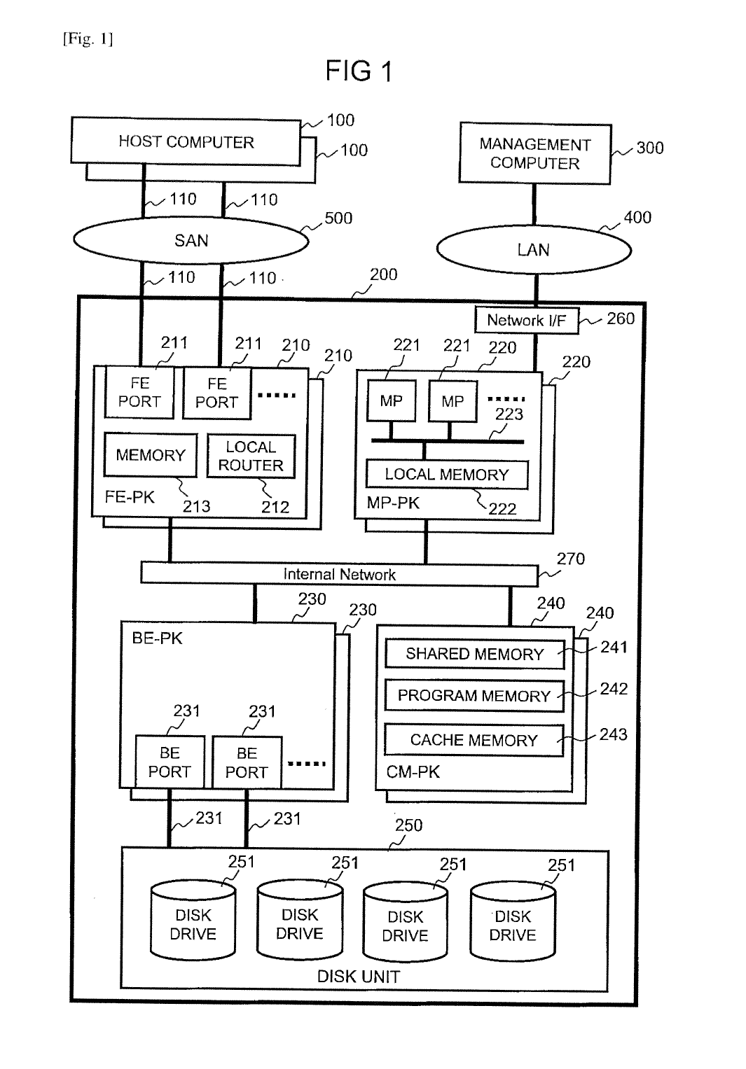

FIG. 1 is a block diagram depicting a computer system (also referred to as a storage system) according to the first embodiment of the present invention.

The computer system comprises at least one host computers 100, a storage subsystem 200 and a management console (also referred to as management computer) 300. The storage subsystem 200 is connected with one or more host computer 100 which reads and writes data via a cable or network. For a network for connecting with the host computer 100, any network that can perform data communication can be used, such as a SAN (Storage Area Network), LAN (Local Area Network), Internet, leased line and public line. In FIG. 1 SAN 500 may be used as an example for connecting the host computers 100 to the storage subsystem 200. For a protocol on a network or cable, any protocol can be used if data can be exchanged between the host computers 100 and the storage subsystem 200, such as Fibre Channel protocol or TCP/IP protocol.

The storage subsystem 200 is broadly divided into one or a plurality of disk units 250 and a controller.

The disk unit 250 is an enclosure for connecting a disk drive 251 to one or more BE (Back End) ports 231. The disk unit 250 has a plurality of disk slots, and one or more one disk drives 251 are inserted into each disk slot. Consequently, the disk unit 250 has a plurality of disk drives 251. The disk drive 251 is a physical storage device (PDEV). The disk drive 251, for example, is a HDD (Hard Disk Drive) or SSD (Solid State Drive). The HDD, for example, can include a SAS (Serial Attached SCSI) drive and a SATA (Serial ATA (Advanced Technology Attachment)) drive. The disk drive 251 is not limited thereto, and other types of disk drives (for example, an FC drive, DVD (Digital Versatile Disk) drive) may also be used. Similarly, other types of PDEV besides the disk drive 251 may also be used.

The controller has a plurality of front end packages (hereinafter, FE-PK) 210, a plurality of Microprocessor packages (hereinafter, MP-PK) 220, a plurality of cache memory packages (hereinafter, CM-PK) 240, a plurality of back end packages (hereinafter, BE-PK) 230, a network interface 260, and an internal network 270. The respective packages are interconnected by way of the internal network (for example, a crossbar switch) 270. Furthermore, at least one of the FE-PK 210, MP-PK 220, CM-PK 240 and BE-PK 230 may number just one.

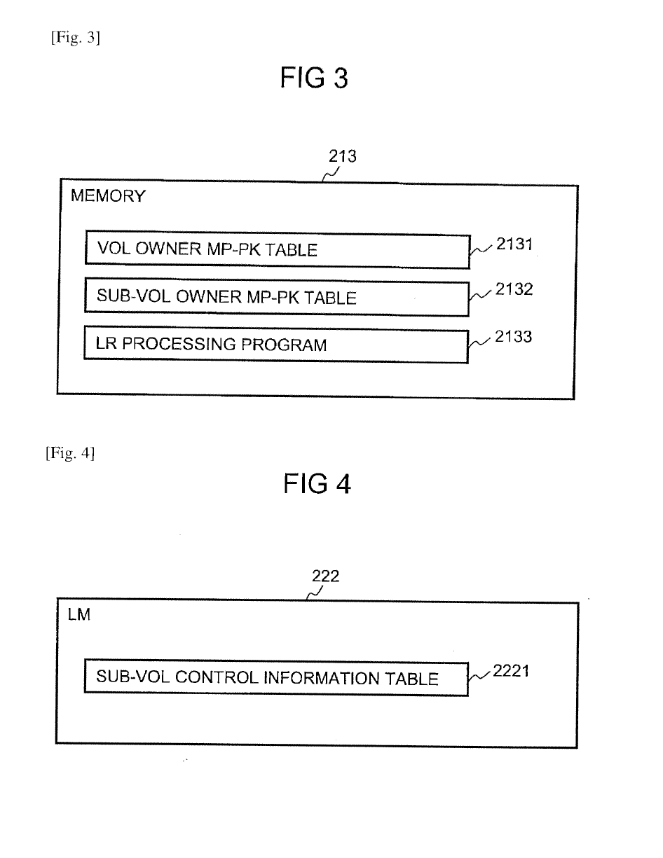

The PE-PK 210 has a plurality of FE (Front End) port 211 and a Local Router 212. The FE port 211 receives the I/O command (write command/read command) from the host 100. The memory 213 is shown later by FIG. 3. The Local Router 212 uses the tables 2131 and 2132 to find out the owner MP-PK 220 of the VOL that corresponds to the VOL number of the received I/O command. The Local Router 212 also finds out the owner MP-PK of Sub-VOL that corresponds to the target address of the I/O command. Local Router then transfers the command to either owner MP-PK 220 of VOL or owner MP-PK 220 of Sub-VOL depending on the type of command, such as write command, read command, reserve command and release command. Furthermore, the prescribed MP-PK 220 may execute the above described process instead of the Local Router 212, since the Local Router 212 may be composed of a processor, one of MP-PKs 220 may operate as the Local Router. Further, the Local Router 212 may be composed of ASIC hardware.

The MP-PK 220 has one or a plurality of MP (microprocessor) 221 and a local memory 222. Further, the MP 221 may be composed as a single core MP or as a multi core MP. The MP 221 executes a variety of processing (for example, the processing of the I/O command from the host 100, and the changing of the VOL owner right etc) by executing a computer program. Further multiple MPs can work in collaboration so that each of the MP of the MP-PK executes a part of the program. Furthermore, each MP of the MP-PK can execute the programs individually for different VOLs or Sub-VOLs, Similarly, each core of the multi core MP can work in collaboration so that each core of the MP executes a part of the program. Also, each core of the MP can execute the programs individually for different VOLs or Sub-VOLs. In this embodiment, a VOL owner right is assigned to each MP-PK 220. Thus, the MP-PK simply can be referred to as a processor unit. However, a VOL owner right can also be assigned to each of the plurality of microprocessor (MP) in the MP-PK 220, Further, a VOL owner right can be assigned to each of the plurality of microprocessor cores of the MP. In that case, the process executed by the MP-PK would be done by the MP that owns the owner right. The local memory 222 is able to store various data, for example, a computer program executed by the MP 221, and control information used by the computer program. In the embodiment of the present invention this local memory 222, stores Sub-VOL control information table 2221. An example of such table is shown in FIG. 8. The MP-PK 220 communicates with the management computer 300 through the network interface 260. The network interface 260 is a communication interface device, for example, a LAN controller.

The CM-PK 240 has one or a plurality of memories. For example, the CM-PK 240 has a shared memory 241 and a program memory 242 and a cache memory 243. The cache memory 243 temporarily stores the host data written to the VOL from the host 100, and the host data read out from the VOL by the host 100. The shared memory 241 stores control information for communicating between MP-PKs. The control information comprises configuration data related to the configuration of the storage subsystem 200. The program memory 242 stores programs to be executed by different MP-PKs. These programs can be cached in the local memory 222 of concerned MP-PK 220.

The BE-PK 230 has more than one BE port 231. A disk drive 251 is communicably connected to the BE port 231.

In this storage subsystem 200, a write command, for example, is processed using the following processing flow. That is, the FE port 211 of the FE-PK 210 receives the write command from the host 100. The Local Router 212 specifics the owner MP-PK 220 of the Sub-VOL (hereinafter, referred to as the “target Sub-VOL” in this paragraph) corresponding to the port number, LUN and write address given in this write command, and transfers this write command to this owner MP-PK 220. In response to this write command, any MP 221 inside the owner MP-PK 220 writes the data accompanying this command (the write data) to the cache memory 243. This MP 221 reports write-complete to the host 100. Any MP 221 inside the owner MP-PK 220 reads the write data out from the cache memory 243, and writes this write data to the disk drive 251 that constitutes the basis of the target VOL.

In this storage subsystem 200, a read command, for example, is processed using the following processing flow. That is, the FE port 211 of the FE-PK 210 receives the read command from the host 100. The Local Router 212 specifies the owner MP-PK 220 of the Sub-VOL (hereinafter, referred to as the “target Sub-VOL” in this paragraph) corresponding to the port number and the LUN inside this read command, and transfers this read command to the owner MP-PK 220. In response to this read command, any MP 220 inside the owner MP-PK 220 first checks if the data is available in the cache memory 243 or not. If the data is available in the cache memory 243, the MP reads out the data from the cache memory 243 and sends the read-out data to the host 100 via FE-PK 211. If the data is not available in the cache memory 243, the MP reads out data in accordance with this command (the read data) from the disk drive 251 that constitutes the basis of the target Sub-VOL, and writes this read data to the cache memory 243. This MP 221 then reads out this data from the cache memory 243, and sends the read-out data to the host 100 via the FE-PK 211.

<Structure of Cache Memory Package (CM-PK)>

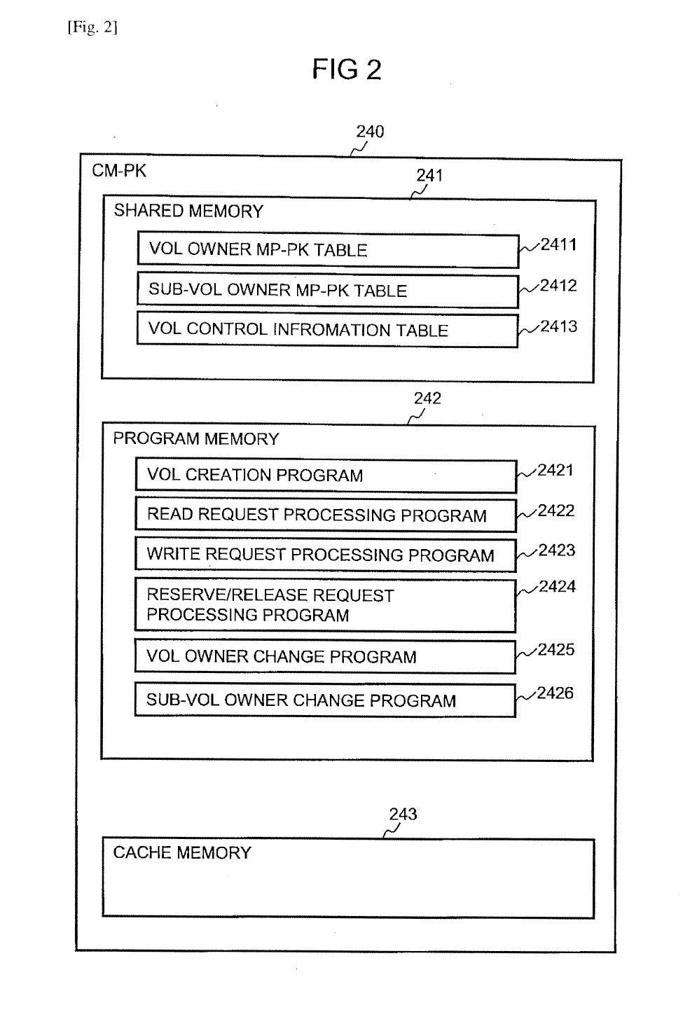

FIG. 2 shows an example structure of cache memory package (CM-PK) 240. It consists of a shared memory 241 that keeps VOL owner MP-PK table 2411, Sub-VOL owner MP-PK table 2412, and VOL control information table 2413; a program memory 242, that keeps the following programs: VOL creation program 2421, Read request processing program 2422, Write request processing program 2423, Reserve/Release request processing program 2424, VOL owner change program 2425, Sub-VOL owner change program 2426. Example of each of the tables in shared memory 241 and example of each of the program in program memory are shown in subsequent figures.

### <Structure of a Memory in FE-PK>

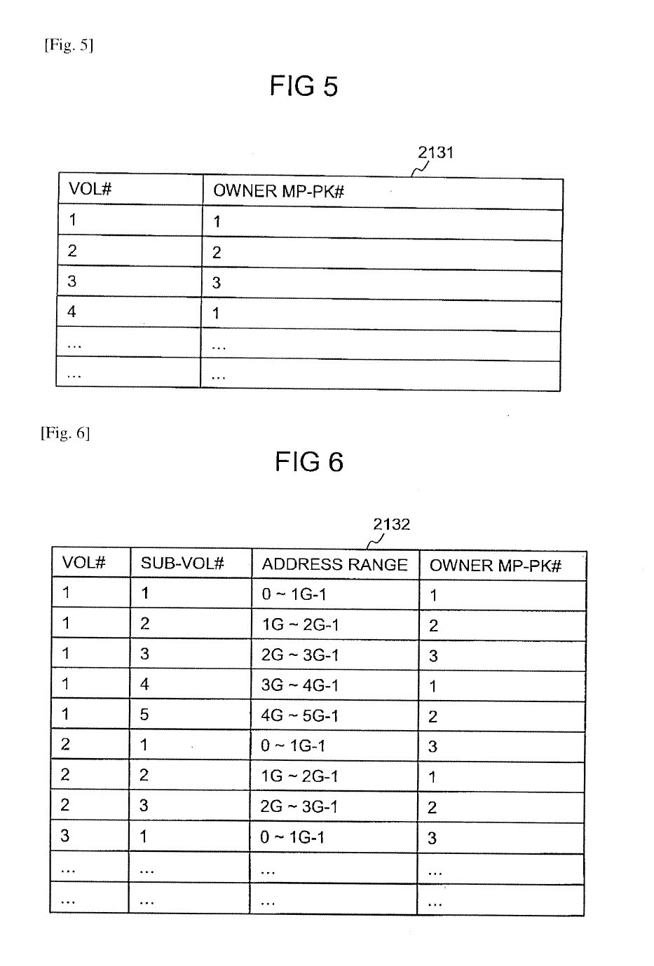

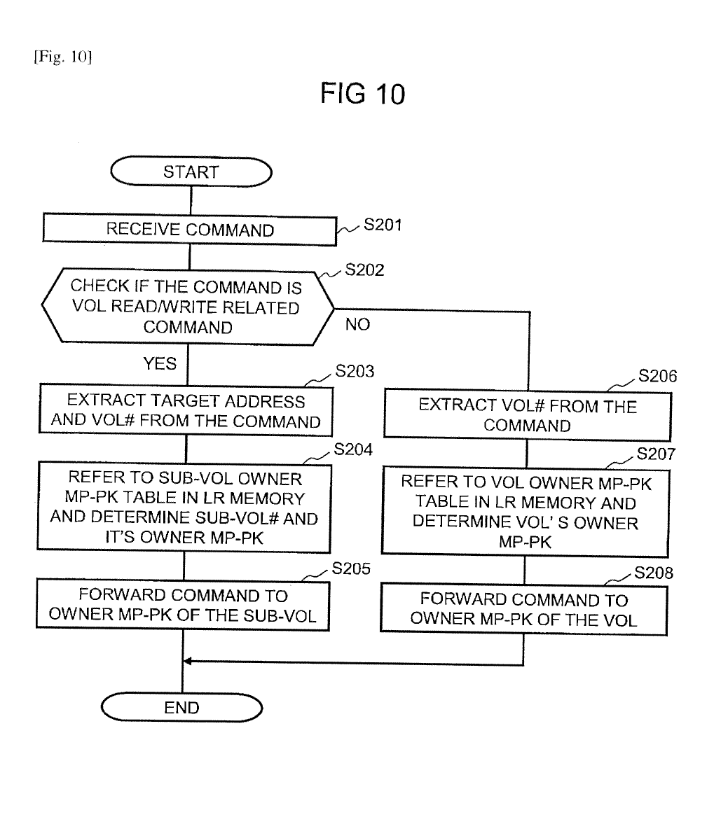

FIG. 3 shows an example structure of memory 213 in FE-PK 210. It consists of a VOL owner MP-PK table 2131, a Sub-VOL owner MP-PK table 2132 and an LR processing program 2133.
Table 2131 keeps the information about owner MP-PK of each VOL in the storage system and is essentially the same as the VOL owner MP-PK table 2411 in SM 241, and is explained later using the FIG. 5. Table 2132 keeps the information about owner MP-PK of each Sub-VOL in the storage system and is essentially the same as the Sub-VOL owner MP-PK table 2412 and is explained later using FIG. 6. These tables, namely 2131 and 2132 are used by LR processing program 2133 which is executed by the LR 212. The LR processing program 2133 gets information about owner MP-PK of VOL and/or a Sub-VOL to which the received command is targeted to. LR then forwards the command to the owner MP-PK. An example of such program is shown in FIG. 10.

### <Structure of Local Memory in MP-PK>

FIG. 4 shows an example structure of Local Memory (LM) 222 in MP-PK. It consists of Sub-VOL control information table 2221, whose example is shown in FIG. 8. For a quick access to the contents of shared memory 241 and program memory 242 by the MP-PK, the LM 222 also keeps a synchronous copy of the contents of the shared memory 241 and the program memory 242 of CM-PK 240. When the contents of the SM or the PM are updated, their synchronous copies in the LM of all the MP-PKs also get updated.

### <Structure of VOL Owner MP-PK Table>

FIG. 5 shows an example of the VOL owner MP-PK table 2131. This table consists of VOL numbers of all the VOLs in the storage subsystem 200 and their corresponding owner MP-PK number.

The VOL number indicates the number which is assigned to each VOL to uniquely identify VOLs of a storage subsystem 200. Owner MP-PK number indicates the number which is used to uniquely determine the owner MP-PK which is responsible for processing commands other than Read/Write commands (i.e. commands that are targeted for complete VOLs) for the VOL uniquely identified by the corresponding VOL number in the table.

<Structure of Sub-VOL Owner MP-PK Table>

FIG. 6 shows an example of the Sub-VOL owner MP-PK table 2132. This table consists of VOL numbers of all the VOLs in the storage subsystem 200, all the Sub-VOL numbers of the VOL, the address range of each Sub-VOL and their corresponding owner MP-PK number.

The VOL number indicates the number which is assigned to each VOL to uniquely identify VOLs of a storage system. Sub-VOL number is the serial number of Sub-VOLs assigned to the each Sub-VOLs, according to the number of Sub-VOLs. To uniquely identify a Sub-VOL in a Storage System, VOL number and Sub-VOL number are used in combination.

Owner MP-PK number indicates the number which is used to uniquely determine the owner MP-PK which is responsible for I/O processing for the Sub-VOL uniquely identified by the corresponding VOL number and Sub-VOL number in the table.

However, since the I/O commands are targeted for a VOL and not for Sub-VOLs, the address ranges of VOL to which each Sub-VOL is associated to, are also kept in the table.

As shown in the table of FIG. 6, the Sub-VOL owner MP-PK for Sub-VOLs in a targeted VOL can be different from the VOL owner MP-PK for the targeted VOL.

<Structure of VOL Control Information Table>

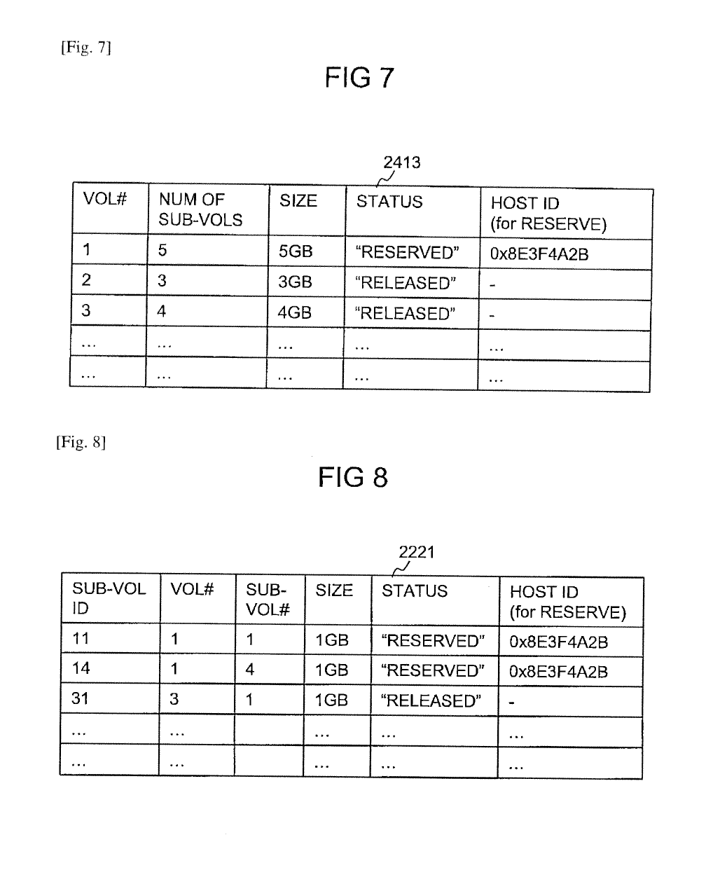

FIG. 7 shows an example of the VOL control information table 2413. It consists of various information related to VOL required to process different commands, targeted for the VOL. Table 2413 exists in SM of CM-PK. And same as table 2411 and 2412, table 2413 gets copied to LM of MP-PK for a faster access of these tables

This information may include VOL number, total number of Sub-VOLs of the VOL, size of the entire VOL, status of the VOL (e.g. VOL is “RESERVED” or not) and the Host ID of the Host Computer for which the VOL is reserved. Host ID is a unique ID which is assigned to each Host Computer to uniquely identify a host from other hosts connected to the same SAN. This ID can be locally unique in the SAN or a globally unique ID.

An example usage of this table is to confirm the status of the VOL (whether it is “RESERVED” or not for a Host Computer) before performing any I/O operation on the VOL.

Here, “RESERVED” means that the targeted VOL is in use by a host computer and the access to the targeted VOL from another host computer is locked. “RELEASED” means that the lock of the access to the targeted VOL is released so that another host computer can access to the targeted VOL.

<Structure of Sub-VOL Control Information Table>

FIG. 8 shows an example of the Sub-VOL control information table 2221. It consists of Sub-VOL ID, Vol number, Sub-VOL number, size of the Sub-VOL, the Status of each Sub-VOL (e.g. Sub-VOL is “RESERVED” or not) and the Host ID of the Host Computer for which the Sub-VOL is reserved.

Sub-VOL ID is an ID to uniquely identify a Sub-VOL in a Storage-System. In this embodiment, this ID is a combination of VOL number and serial number of Sub-VOL. Definition of VOL number. Sub-VOL number and Host ID is the same as in table 2131, 2132 and 2413 respectively. This table consists of information only for the Sub-VOLs whose owner MP-PK is the MP-PK of the LM in which the table exists. The VOL owner MP-PK writes “RESERVED” or “RELEASED” in the Status column of each Sub-VOL in the Sub-VOL control information table 2221. The meanings of “RESERVED” and “RELEASED” are the same as in the VOL control information table 2413.

### <VOL Creation Processing>

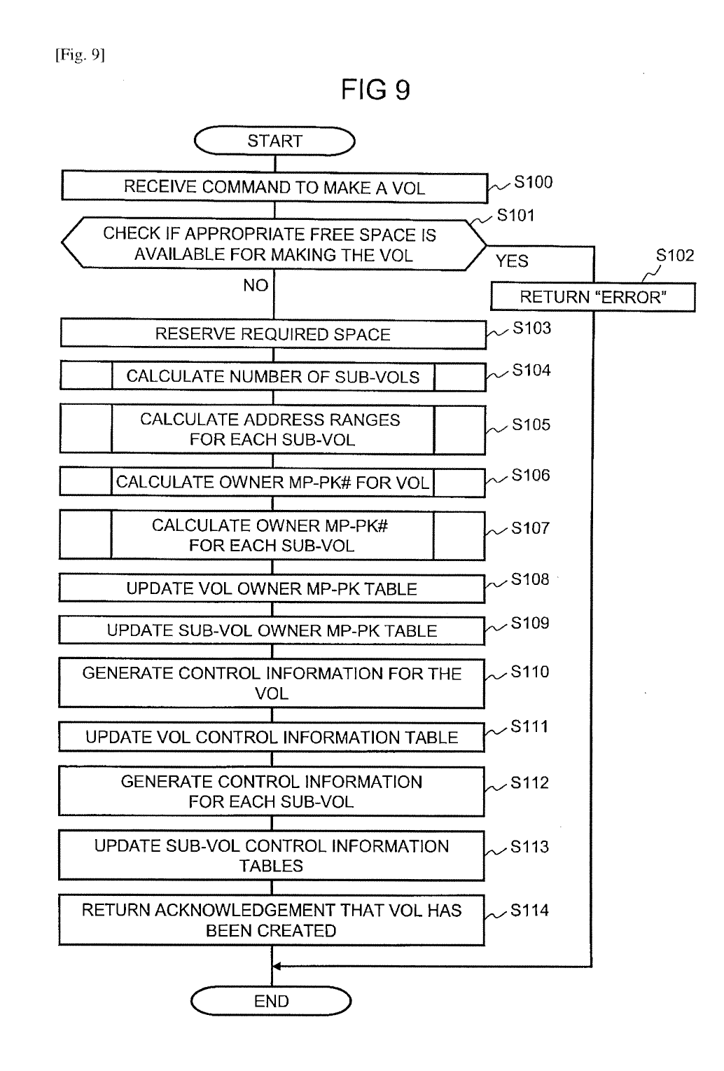

FIG. 9 is a flowchart depicting VOL creation processing by VOL creation program 2421 according to the embodiment of present invention. This VOL creation program is a program to create a new VOL (hereinafter, referred to as the “target VOL”) in the storage subsystem 200. This program is executed by a MP-PK 220 which may not necessarily be the owner MP-PK of the VOL.

As shown in FIG. 9, in step S100, an MP-PK first receives a VOL creation command from the management computer 300 via LAN 400 and the Network I/F 260. This VOL creation command includes control information about the target-VOL such as the size of the VOL, VOL ID and RAID group etc.

In step S101, the MP-PK 220 checks if the requested VOL size is more than the available free space in the storage subsystem 200. If the requested size is not available in the storage system, the process goes to S102 and the MP-PK returns error to the management computer and the program ends (S102). On the other hand, if the storage subsystem 200 has sufficient free space to accommodate the new VOL, the MP-PK executes step S103 to S114 in order to create the target-VOL.

In step S103, the MP-PK reserves the space in one or more Disk Drives 251, required to make the target-VOL.

In step S104, MP-PK uses a mathematical formula to calculate the number of Sub-VOL required to be made for the target-VOL. The mathematical formula used in step S104 for example can be a fractional division of the size of target-VOL by a prefixed Sub-VOL size. If the result of the division is a fractional number, it will be rounded up to the next integer to give the size of each of the Sub-Vols. For example if the target-VOL size is 16 GB and the prefix Sub-VOL size is 5 GB, dividing 16 GB by 5 GB gives 3.2, now rounding up this result to the next integer gives 4. Hence, four Sub-VOLs of 5 GB each should be made for the target-VOL. Alternatively, the number of Sub-VOLs may be determined based on the number of the MP-PKs so that each MP-PK may be responsible for one of the created Sub-VOLs, respectively. For example, if the target-VOL size is 16 GB and the number of available MP-PK is 5, then 5 Sub-VOLs will be made. Now, to find out the size of each Sub-VOL, the target VOL size 16 GB is divided by 5 giving 3.2 GB. Thus, 5 Sub-VOLs will be made of 3.2 GB each.

Next, in step S105, the MP-PK calculates the address ranges of target-VOL corresponding to each Sub-VOL, using mathematical formula. This mathematical formula for example can be incremental address ranges of the prefixed Sub-VOL size for consecutive Sub-VOL starting from the address 0. For example, if the target-VOL size is 16 GB and prefix Sub-VOL size is 5 GB then the address ranges for 4 Sub-VOL will be 0˜5G-1, 5G˜10G-1, 10G˜15G-1, 15G˜20G-1 respectively.

In step S106, MP-PK determines the owner MP-PK for the target-VOL by a predetermined rule. For example, the MP-PK can refer to the VOL owner MP-PK table and find out the last allocated owner MP-PK# and use the round-robin technique to find the VOL owner MP-PK# of the target-VOL. Another example of a technique to determine the owner MP-PK is calculating the MP-PK utilization rate for each MP-PK and selecting the MP-PK with the least utilization rate. The MP-PK utilization rate is the average of processor utilization rate of each MP of a MP-PK or a consolidated processor utilization rate of all the MPs for each MP-PK. The calculation of processor utilization rate of an MP is a well known prior art and is not explained in this context.

Next, in step S107, the MP-PK determines Sub-VOL owner MP-PK for each Sub-VOL of the target-VOL. The rule explained in S106 is used here by referring Sub VOL owner MP-PK table.

In the step S108, MP-PK updates the VOL owner MP-PK table 2411 in shared memory 241 and the VOL owner MP-PK table 2131 in memory 213 of PE-PK 210 with the information of target-VOL and the owner MP-PK of the target VOL.

In step S109, MP-PK updates the Sub-VOL owner MP-PK table 2412 in local memory 222 of each MP-PK 220 and also the Sub-VOL owner MP-PK table 2132 in memory 213 of FE-PK 210 with the information about Sub-VOL of the target-VOL and the Sub-VOL owner MP-PK.

In step S110, MP-PK generates control information for the target-VOL and in step S111, the MP-PK updates the VOL control information table 2413 in SM 241 with the generated information as well as with the information received with the VOL create command.

In step S112, the MP-PK generates control information for each Sub-VOL of the target VOL and in step S113, the MP-PK updates the Sub-VOL control information table 2221 in LM 222 of each MP-PK 220 with this information.

Now once the tables are updated, the MP-PK returns acknowledgment (S114) that the VOL (target-VOL) has been created and the program ends.

<Distribution Processing by Local Router>

FIG. 10 is a flowchart depicting the distribution processing of commands executed by Local Router (LR) 212 on receiving a command from the Host Computer 100. First, in step S201, the LR 212 receives a command from the Host Computer 100. In step 202, LR 212 then analyzes the command and finds out whether the command is a VOL read/write related command or other type commands that are related to an entire VOL, e.g. VOL status change command. If it's a VOL read/write related command, the process goes to step S203. If its one of the other types of command, the process goes to step S206.

In step S203, the LR 212 extracts target address of the command and the VOL# from the command. The LR 212 then refers to the Sub-VOL owner MP-PK table 2132 in memory 213 and finds out the Sub-VOL# (target sub-VOL) for the target address and also the owner MP-PK for this target Sub-VOL.

In next step S205, the LR 212 forwards the command to this owner MP-PK for processing.

In step S202, if the command was not read/write related command (the other type of commands), then the command should be processed by the VOL owner MP-PK and not the Sub-VOL owner MP-PK. Hence, LR 212 takes steps to forward the command to the VOL owner MP-PK of the target-VOL.

In step S206 LR 212 extracts VOL# from the command and in step S207, it refers to the VOL owner MP-PK table 2131 in memory 213 and finds out the owner MP-PK of the target-VOL.

Finally, in step S208, the LR 212 forwards the command to owner MP-PK of the target-VOL for processing.

<Read Command/Request Processing by Sub-VOL Owner MP-PK>

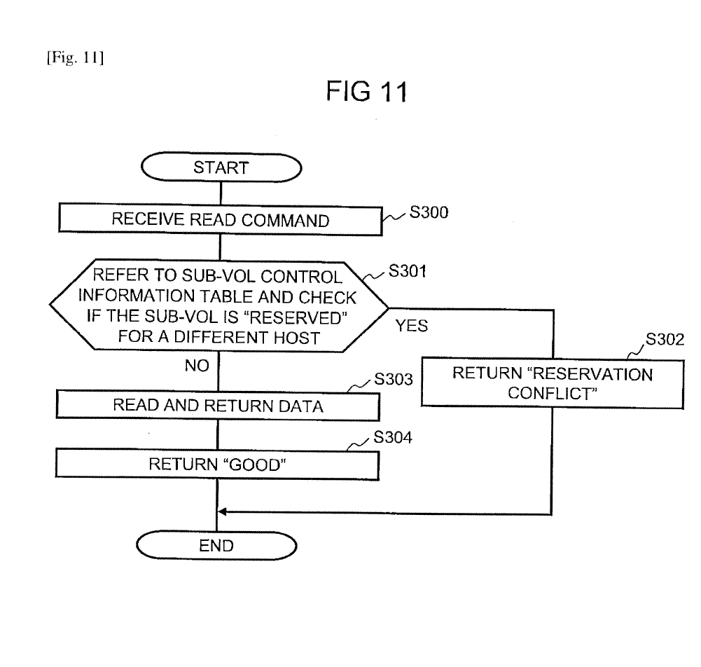

FIG. 11 is a flowchart depicting read processing according to read request processing program 2422 executed by Sub-VOL owner MP-PK on receiving a read command.

In step S300, the Sub-VOL owner MP-PK receives a read command which is directed to it by the LR 212 in step S205.

In step S301, the Sub-VOL owner MP-PK refers to the Sub-VOL control information table 2221 and checks if there is any reservation conflict. If the status of Sub-VOL is “RESERVED” and the Host Computer 100 is different than the one which sent the read command (that is, the target Sub-VOL is in use by another Host Computer 100), then the MP-PK returns “RESERVATION CONFLICT” to the Host Computer 100 in step S302 and the program ends.

On the other hand, if the Sub-VOL is either “RELEASED” or the “RESERVED” for the same Host Computer 100 which sent this read command, then the MP-PK moves the process to step S303.

In step S303, the Sub-VOL owner MP-PK reads the requested data either from the cache or from the disks and returns the data to the Host Computer which has sent the read command.

Once the data transfer completes, in step S304, MP-PK returns “GOOD” to the Host Computer which has sent the read command and the program ends.

### <Processing of Write Commands by Sub-VOL Owner MP-PK>

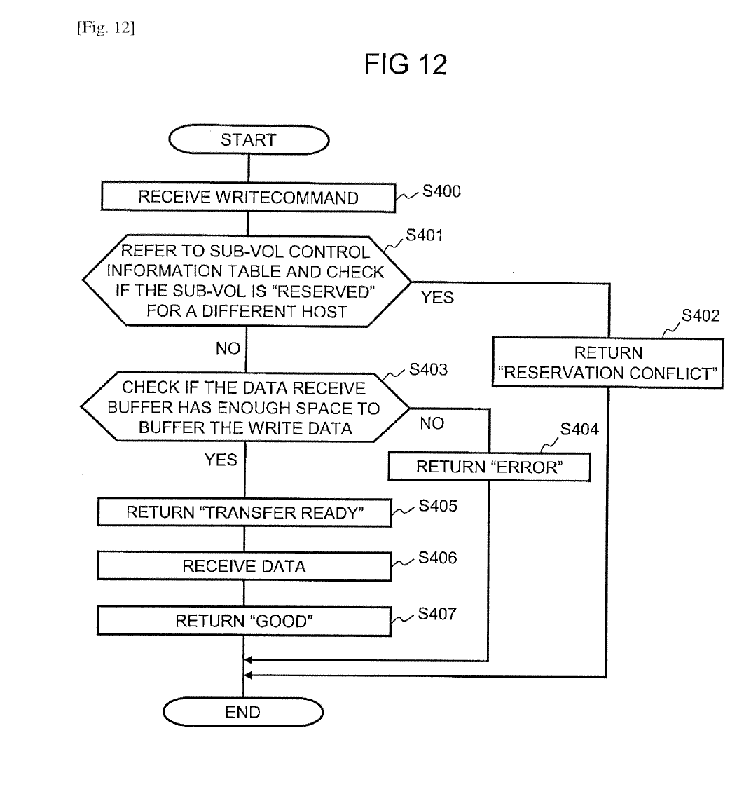

FIG. 12 is a flowchart depicting the processing of a write command according to write request processing program 2423 executed by Sub-VOL owner MP-PK on receiving a write command.
In step S400, the Sub-VOL owner MP-PK receives a write command which is directed to it by the LR 212 in step S205.
In step S401, the Sub-VOL owner MP-PK refers to the Sub-VOL control information table 2221 and checks if there is any reservation conflict as explained in S301. If the Sub-VOL is either “RELEASED” or “RESERVED” for the same Host Computer 100 which sent this write command, then the MP-PK moves the process to step S403.
In step S403 the MP-PK checks if the data receive buffer has enough space to buffer the data which will be sent by the Host Computer 100. If there is not enough space in data receive buffer the MP-PK returns “ERROR” to the Host Computer which has sent the write command and the program ends.
On the other hand, if it is determined that there is enough space in data receive buffer to receive the data sent by the Host Computer 100 in step S403, the MP-PK returns “TRANSFER READY” to the Host Computer which has sent the write command in step S405 and waits for the host to send data. On receiving the “TRANSFER READY” from the storage subsystem 200, the Host Computer 100 sends the data related to the write command.
In step S406, the owner MP-PK of storage subsystem 200 receives this data in the data receive buffer and in step S407, the MP-PK returns “GOOD” to the Host Computer 100 and the program ends.
The de-staging of this data from the data receive buffer to the disk drives 251 will be performed by a different program. This data de-staging process is widely known and is not described in this context.

### <Processing of RESERVE and RELEASE Commands by VOL Owner MP-PK>

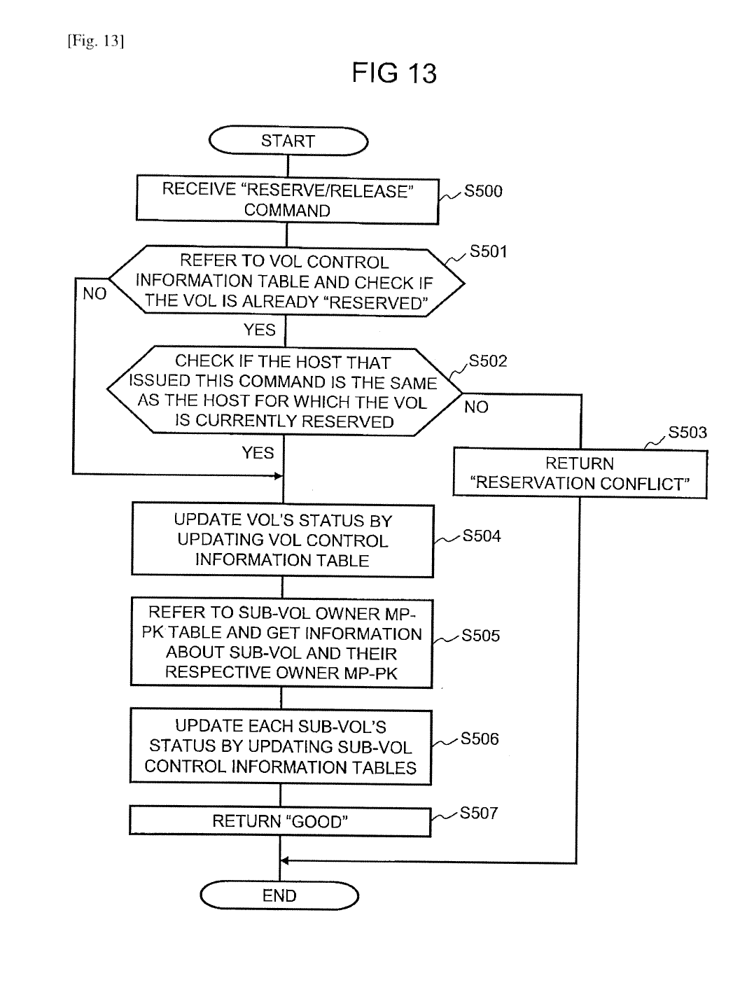

FIG. 13 is a flow chart depicting the processing of RESERVE and RELEASE commands according to reserve/release request program 2424 executed by the VOL owner MP-PK on receiving a “RESERVE” or “RELEASE” command for a VOL. Since these commands are associated with processing of an entire VOL and not limited to a region of a VOL (as in the case of Read/Write commands), these commands are processed by the VOL owner MP-PK.

In step S500, the VOL owner MP-PK receives a “RESERVE” or “RELEASE” command from one of the Host Computers 100. This command is forwarded to the VOL owner MP-PK by LR 212 in step S208 according to the LR processing program 2133.

After receiving the command, in step S501, the VOL owner MP-PK looks at the VOL control information table 2413 and checks if the target VOL is already reserved or not (The VOL is locked because being in use by another Host Computer or the VOL is not locked for use by any Host Computer). If the VOL is not already reserved, the VOL owner MP-PK moves the process to step S504.

On the other hand, if the VOL is already reserved, in step S502, the MP-PK checks whether the Host Computer 100 that has issued the command is the same as the Host Computer 100 for which the VOL is currently reserved. If the Host Computers 100 are not the same, the VOL owner MP-PK returns “RESERVATION CONFLICT” to the Host Computer that has issued the command and the program ends.

In step S504, the VOL owner MP-PK updates the status of the target-VOL to either “RESERVED” or “RELEASED” by updating the VOL control information table 2413 in SM 241.

Now, the status of each Sub-VOL of the target-VOL should be updated similarly in order to make sure that Sub-VOL owner MP-PK on receiving the read/write related commands, read the status of Sub-VOL same as the status of VOL. Thus, in step S505, the VOL owner MP-PK refers to the Sub-VOL owner MP-PK table 2412 and gets the information about all the Sub-VOL of the target-VOL and their respective owner MP-PKs.

Next, in step S506, the VOL owner MP-PK updates the Sub-VOL status to either “RESERVED” or “RELEASED” according to the received command, by updating the Sub-VOL control information table 2221 in LM 222 of each Sub-VOL owner MP-PK which is responsible for the Sub-VOLs of the target-VOL.

In step S507, the VOL owner MP-PK returns “GOOD” to the Host Computer that has issued the command and then the program ends.

<Processing of VOL Owner Change Program and Sub-VOL Owner Change Program>

The VOL owner change program 2425 is a program to change the owner MP-PK of a VOL and to update the VOL owner MP-PK tables 2131 accordingly as shown in U.S. Pat. No. 7,912,996B2. Since a Sub-VOL is essentially a smaller VOL, the Sub-VOL owner change program 2426 is also similar to the VOL owner change program 2425 except for the fact that, instead of VOL owner MPPK tables 2131, the Sub-VOL owner MPPK tables 2132 in LM 222 and in Memory 213 are updated.

<Sub-VOL Size/Numbers Change>

Also, since the load caused by any VOL can change dynamically (with time), the size and number of sub-VOLs for a VOL can also change based on the new result of the calculation. One of the MP-PKs acquires information of utilization rate of each MP-PK or determines the utilization rate of each MP-PK by monitoring I/Os to each MP-PK, and renders/distributes the ownership of the sub-volumes of a logical volume to MP-PK such that the utilization rate of each MP-PK becomes equal or almost equal. For, example, the ownership of some VOLs of a MP-PK with high utilization rate can be transferred to other MP-PK(s) with relatively less utilization rate for an even distribution of utilization rate of MP-PKs. Similarly, load on MP-PK generated by each VOL can be determined by counting the I/O for each VOL, and the ownership of VOL can be reshuffled so that the total load on an MP-PK due to the VOLs it owns becomes the same or almost same as the load on other MP-PKs. The storage system can autonomously decide to perform this change periodically or when the load on one or more processor units crosses a threshold value. A storage administrator can also decide to perform this change based on the similar calculation and/or with his input parameters. With this architecture it is possible to ensure the even load distribution to each processor unit.

In embodiment 1, by dividing a VOL in multiple smaller Sub-VOLs and distributing their ownership to multiple MP-PKs, the load generated by a single VOL on a MP-PK can be distributed to multiple MP-PKs, giving an even distribution of load between plurality of MP-PK. This results in a higher degree of utilization of microprocessors and hence the performance of storage system is improved. This result is more profound when the VOLs are very big in size. This invention is particularly useful in big data applications, where the VOL size is huge and it will be more efficient if parts of the VOL are owned by plurality of MP-PKs rather than the case when the complete VOL is owned by a single processor unit.

### (2) Embodiment 2

This embodiment relates to implementing a VOL copy technique, using Sub-VOLs. This technique makes a full copy of a VOL within the same Storage subsystem 200. In this embodiment, asynchronous full copy technique is explained. However, with the similar principle synchronous full copy technique can also be implemented using Sub-VOLs. In this technique the owner of primary VOL and secondary VOL (copy VOL) are made to be the same. Also the owner of each of primary Sub-VOLs and the corresponding secondary Sub-VOLs (copy Sub-VOL) are made to be the same respectively. (e.g. the owner of primary Sub-VOL#1 and the corresponding secondary Sub-VOL#1 is a single MP-PK, while the owner of primary Sub-VOL#2 and the corresponding secondary Sub-VOL#2 is also single MP-PK, which may or may not be the same as the owner MP-PK for primary and secondary Sub-VOL pair)

In terms of the configuration of a computer system of this embodiment, the same computer system depicted in FIG. 1 can also be applied.

<Structure of Cache Memory Package>

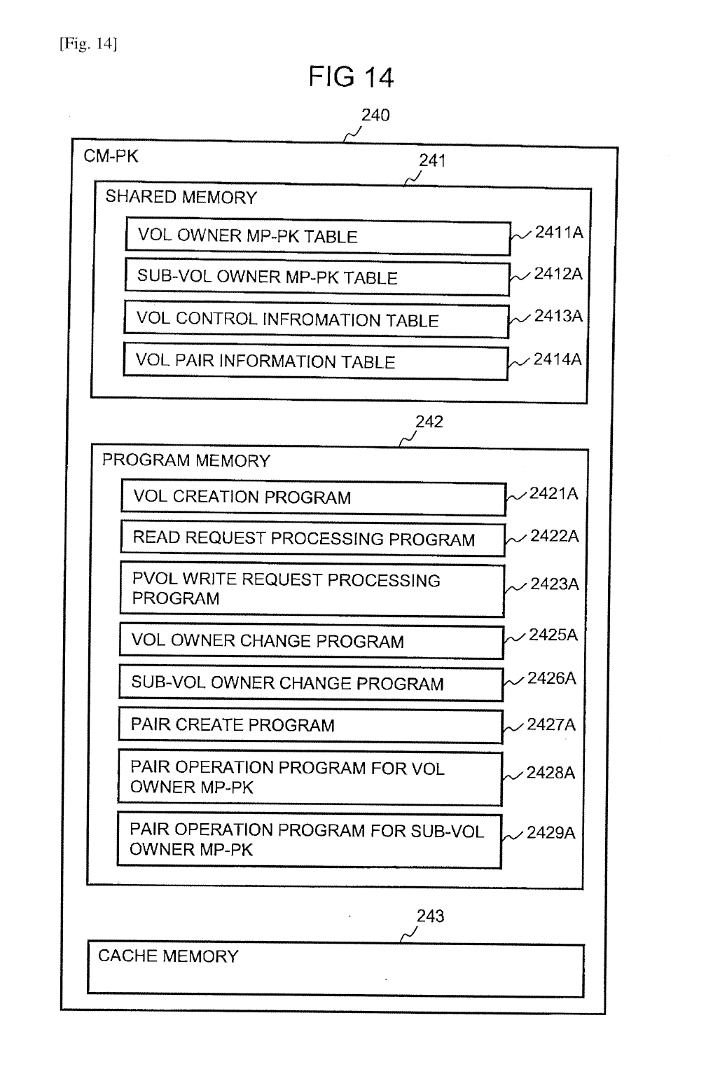

FIG. 14 shows an example structure of cache memory package (CM-PK) 240 for this embodiment. In this section, the difference from the CM-PK 240 in FIG. 2 is explained below.
The shared memory 241 further includes the VOL pair information table 2414A which is explained later with FIG. 16.
The VOL owner MP-PK table 2411A, the Sub-VOL owner MP-PK table 2412A, the VOL control information table 2413A, are each correspond to the table 2411, table 2412, table 2413 respectively.

An example of the contents of program memory is also shown in FIG. 14. It consists of a VOL creation program 2421A corresponding to the 2421 (See FIG. 9), Read request processing program 2422A, PVOL write request processing program 2423A, VOL owner change program 2425A and a Sub-VOL owner change program 2426A, pair create program 2427A, pair operation program for VOL owner MP-PK 2428A and pair operation program for Sub-VOL owner MP-PK 2429A.

The read request processing program 2422A is used to process the read operation related commands/requests. Since the PVOL and SVOL have the same properties as a VOL, this program is common for both PVOL and SVOL read operations. This program is the same as the read request processing program for the embodiment 1 for Simplex VOL shown in FIG. 11. “Simplex” state means a state where there is no dependence relationship in the pair volumes (PVOL and SVOL).

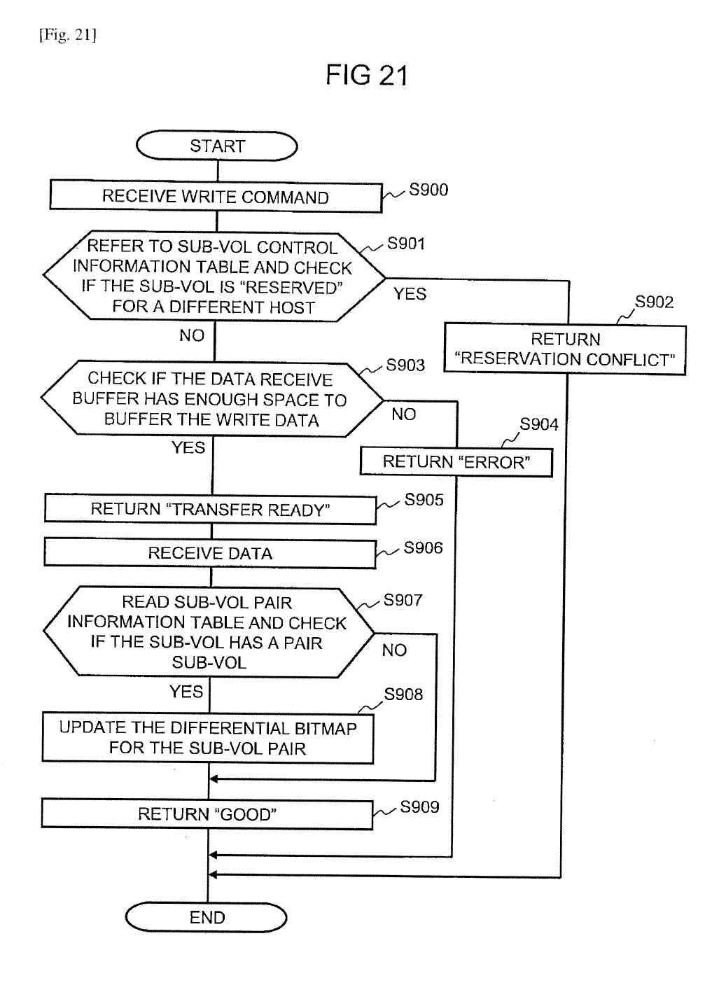

The PVOL write request processing program 2423A is used to process the write operation related commands/requests. An example of flowchart of the program is shown in FIG. 21 and explained later in this context.

The VOL owner change program 2425A corresponds to 2425 and the Sub-VOL owner change program 2426A corresponds to the VOL owner change program 2426.

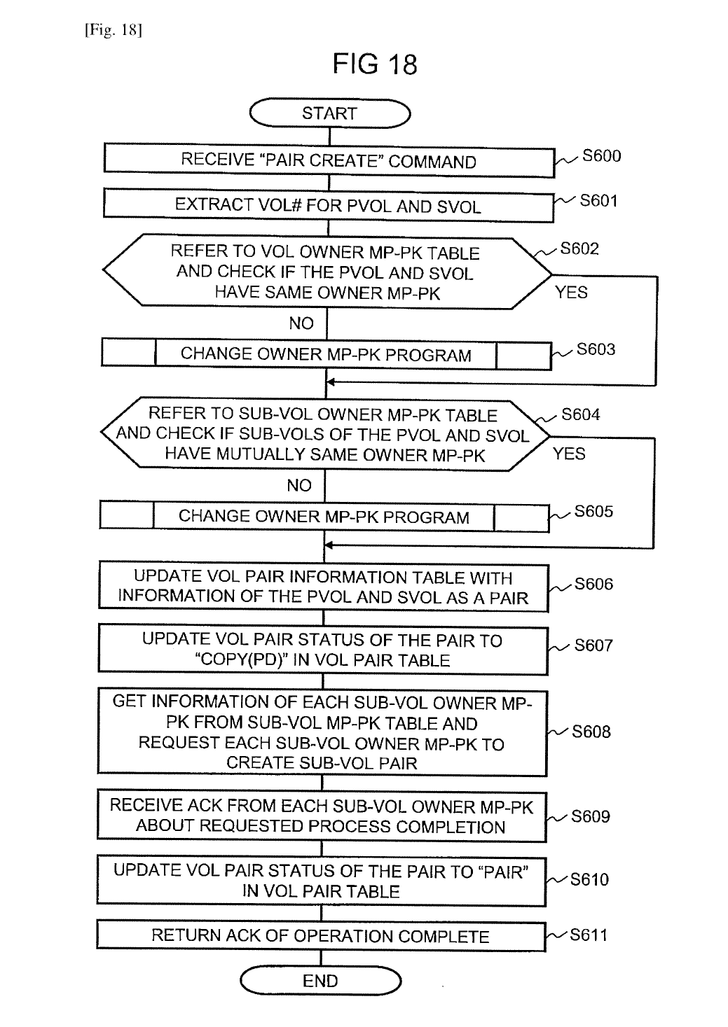

The pair create program 2427A is used to create copy pair. It is explained later using a flowchart of FIG. 18.

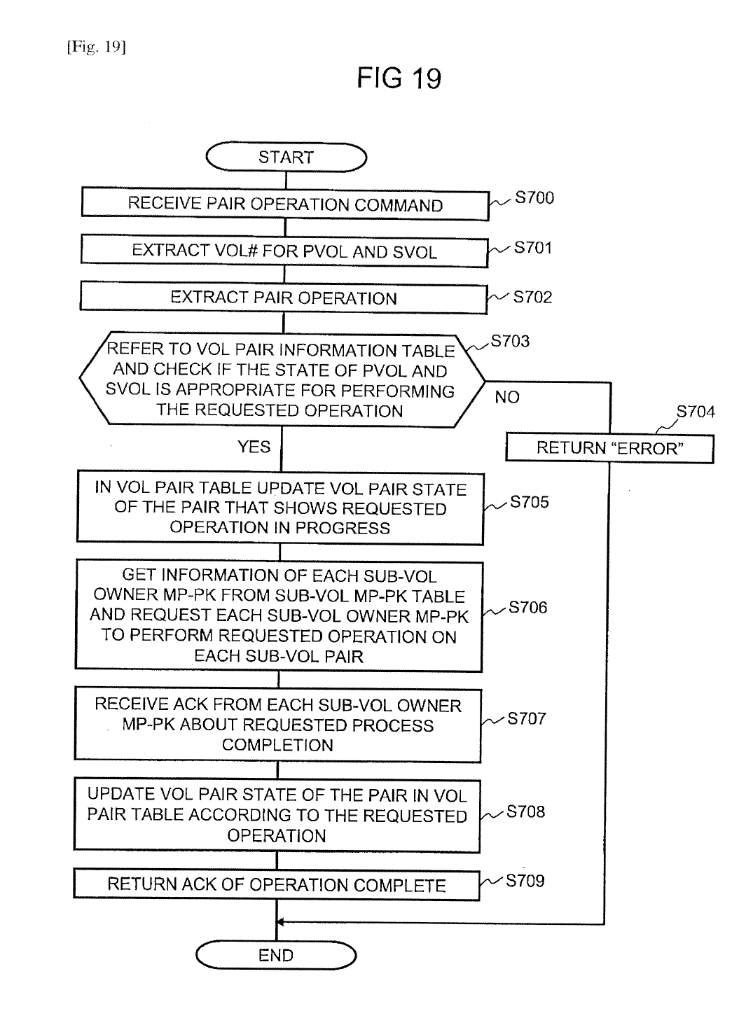

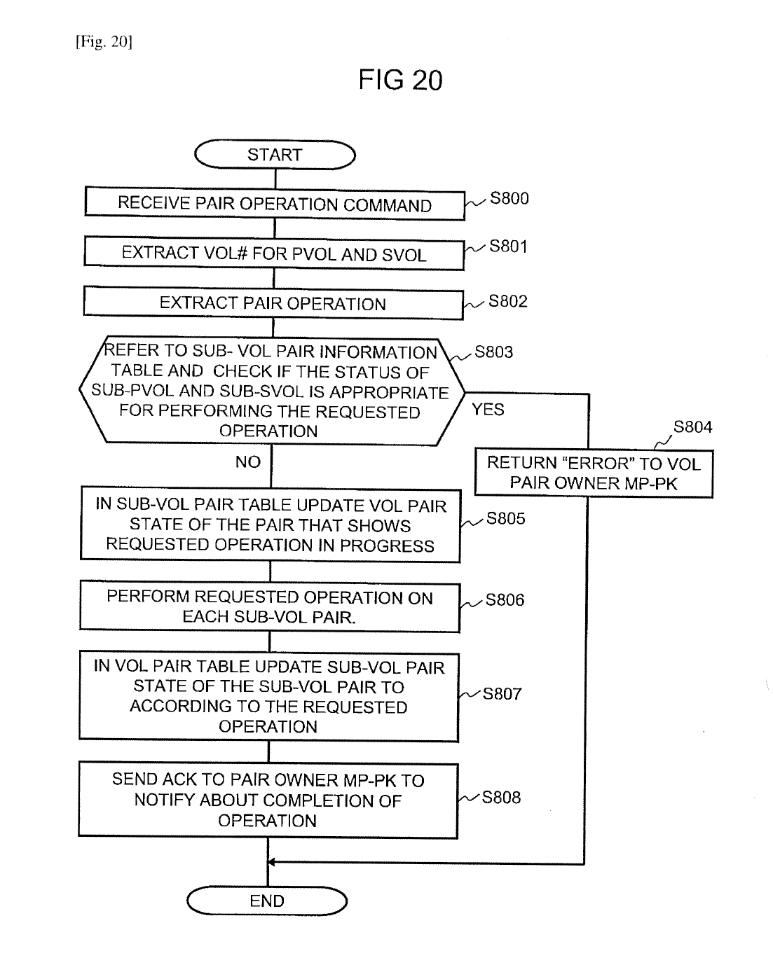

A pair operation program 2428A performs Shadow Image copy pair related operations such as pair split/pair resync etc. This program is executed by the VOL owner MP-PK of the PVOL/SVOL pair but it is compensated by pair operation program for Sub-VOL owner MP-PK 2429A that is executed by the owner MP-PKs of each Sub-PVOL (Sub-VOL of PVOL)/Sub-SVOL (Sub-VOL of SVOL) pair. The flowcharts of programs 2428A and 2429A are shown in FIG. 19 and FIG. 20 respectively.

<Structure of Memory 213 in FE-PK 210>

The structure of memory 213 in FE-PK 210 in this embodiment is the same as in the embodiment 1. Tables 2131 and 2132 are also used in this embodiment for the same purpose.

<LR Processing Program 2133>

The LR processing program 2133 of the embodiment 1 is also used in this embodiment for the same purpose, and additionally it also forwards the copy pair related commands to VOL (PVOL/SVOL pair) owner MP-PK. As is shown in the flowchart of the LR processing program in FIG. 10, in step S202, commands other than the VOL (PVOL or SVOL) read/write commands (these other commands also include copy pair related commands) are forwarded to VOL (PVOL/SVOL) owner MP-PK via steps S206 to S208.

### <Structure of Local Memory in MP-PK>

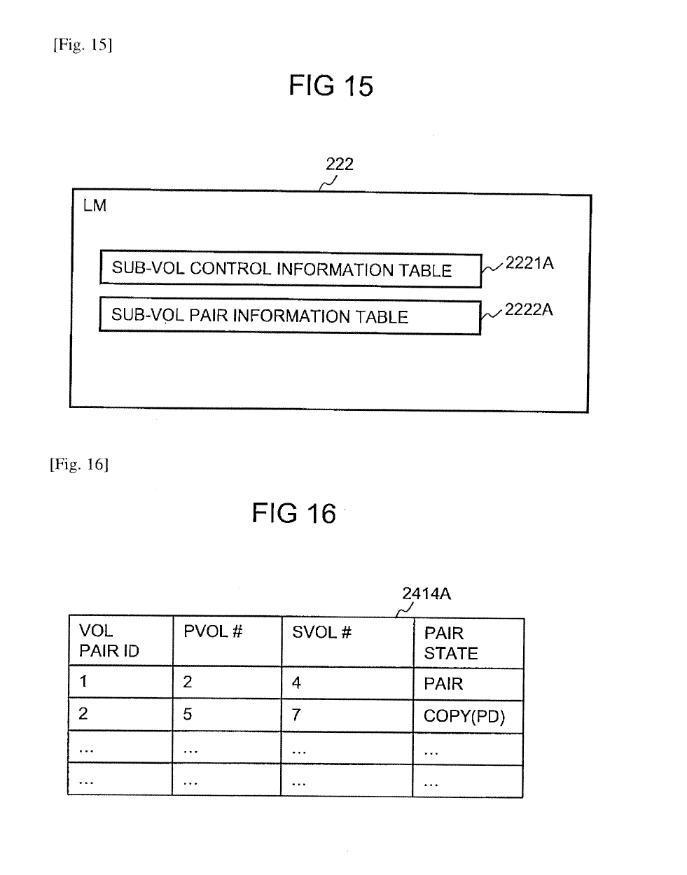

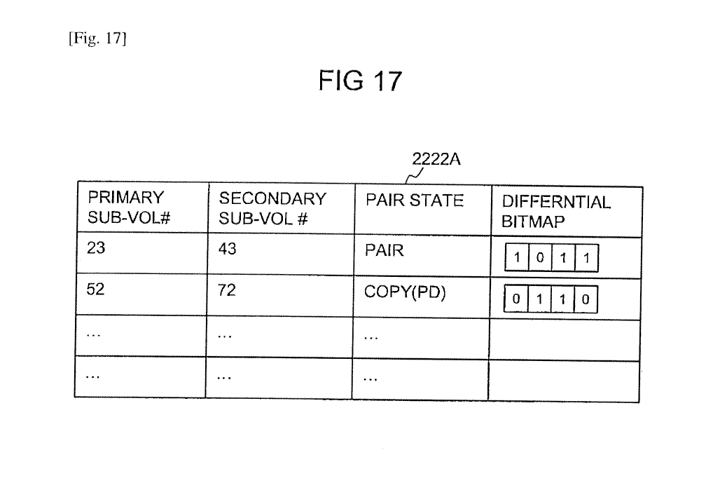

FIG. 15 shows an example of the structure of local memory (LM) 222. It consists of a Sub-VOL control information table 2221A corresponds to the 2221 in FIG. 8, and a Sub-VOL pair information table 2222A.
The Sub-VOL pair information table 2222A is explained later with FIG. 17.

### <Structure of VOL Pair Information Table>

FIG. 16 shows an example of VOL pair information table 2414A. The VOL pair information table 2414A keeps information about copy VOL pairs. This table includes copy VOL pair IDs. PVOL number, SVOL number and pair state. The copy VOL pair ID is a unique number for each copy VOL pair in the storage subsystem 200. The pair state shows the state of the copy VOL pair. For example, if the field has “PAIR” as its value, it means the corresponding VOL pair is in pair state. “COPY (PD)” means the corresponding VOL pair is in COPY pending state. The COPY pending state means that the processing of the initial copy operation of the contents of PVOL into SVOL is in progress. “PSUS” means the corresponding VOL pair is in split state. That is, the Sub-SVOL retains the contents of the Sub-PVOL at time of performing the pair split operation and the content of the Sub-SVOL stays unchanged even if the content of the Sub-PVOL is changed after the pair split operation.

### <Structure of Sub-VOL Pair Information Table>

FIG. 17 shows an example of Sub-VOL pair information table 2222A. This table keeps information about copy Sub-VOL pairs. The Sub-VOL pair information table 2222A includes Sub-PVOL number, Sub-SVOL number, pair state and Differential Bitmap as its fields. The same Sub-VOL owner MP-PK is responsible for handling the Sub-PVOL and the corresponding Sub-SVOL.
The pair state field shows the state of the copy Sub-VOL pair. The pair state includes, as its values. PAIR state, COPY (PD) state, PSUS state and so on as explained above. The Differential Bitmap field keeps a bitmap which shows that there is some difference between Logical Block Addresses of Sub-PVOL and Sub-SVOL. For example, if, at time T1, the Sub-PVOL and Sub-SVOL are completely the same, the bitmap of the LBAs will all be zeros. Now if, at time T2 (>T1), a write came to a particular LBA of the Sub-PVOL and the Sub-PVOL gets updated at that LBA. Now, for that LBA the Sub-PVOL and Sub-SVOL are different, hence the location of that LBA in bitmap field will be set to 1, representing that the Sub-PVOL is different than the Sub-SVOL for that LBA.

### <Pair Create Operation>

FIG. 18 is a flowchart depicting the pair create operation by pair create program 2427A. This processing is to pair PVOL and SVOL which are already created but are not yet associated with each other. The pair create program 2427A is a program to set the two VOLs in pair state so that the copy operation can be performed. The program shown in FIG. 18 is executed by the owner MP-PK of PVOL, however a part (S608) of the entire pair creation process is performed by the Sub-VOL owner MP-PK and its flowchart is shown in FIG. 20.
In step S600, an owner MP-PK of a PVOL (referred to as PVOL owner MP-PK) first receives a pair create command from the Host Computer 100, and, in step S601, the MP-PK extracts from the command VOL numbers for PVOL and SVOL (hereinafter, referred to as the “target PVOL” and “target SVOL” in this paragraph) of the copy pair. In step S602, it looks up the VOL owner MP-PK table 2411A to confirm whether the target PVOL and target SVOL have the same owner or not. If they have the same owner, the target PVOL owner MP-PK moves the process to step S604. But if the target PVOL/SVOL pair do not have the same owner MP-PK (itself), the target PVOL owner MP-PK moves the process to step S603 and execute the VOL owner change program 2425A to change the owner authority of target SVOL to make it same as target PVOL owner MP-PK.
Next, in step S604, the target PVOL owner MP-PK checks whether the owner authority of each Sub-VOL of target SVOL is the same as that of the corresponding Sub-VOL of target PVOL. If they have the same owner, the target PVOL owner MP-PK moves the process to step S606. But if they do not have the same owner MP-PK, the target PVOL owner MP-PK moves the process to step S605 and executes the Sub-VOL owner change program 2426A to change the owner authority of all the Sub-VOLs of target SVOL to make it same as that of the Sub-VOLs of target PVOL. At reaching step S606, the target PVOL and target SVOL have the same VOL owner MP-PK. Also each Sub-VOL of PVOL/SVOL pair has the same owner. Now, in step S606, the PVOL owner MP-PK adds the information of the target PVOL/SVOL as a pair in the VOL pair information table 2414A.
Next in step S607, the PVOL owner MP-PK updates the VOL pair status in the VOL pair information table 2414A as COPY(PD). COPY(PD) is a status which denotes that the initial copy is in progress.
In step S608, the initial copy from target PVOL to target SVOL must be performed. However, since read and write operations to a Sub-VOL are only performed by the Sub-VOL owner MP-PK, the PVOL owner MP-PK now looks at the Sub-VOL owner MP-PK table 2412A and gets information about all the Sub-VOL owner MP-PKs of the target PVOL/SVOLs. The PVOL owner MP-PK then requests each Sub-VOL owner MP-PK to take steps in order to create Sub-VOL pair and perform initial copy from Sub-PVOL to the corresponding Sub-SVOL. The detailed processing of step S608 is shown in FIG. 20 and thus will be explained later.

In step S609, the PVOL owner MP-PK waits for each Sub-VOL pair owner MP-PK to complete the Sub-VOL pair creation and initial copy operation. If the each Sub-VOL pair owner MP-PK completes the requested operation, it acknowledges to the VOL pair owner MP-PK (the owner MP-PK of PVOL and SVOL) about the completion.

After getting acknowledgements from all Sub-VOL owner MP-PKs, the PVOL owner MP-PK moves the process to step S610. In step S610, the PVOL owner MP-PK updates the pair state as “PAIR”, in the VOL pair information table 2414A.

In step S611, the PVOL owner MP-PK returns acknowledgement to the Host Computer 100 about completion of the copy pair creation operation and the program ends.

<Pair Operations (Pair Split and Pair Resync) for PVOL and SVOL>

FIG. 19 is a flowchart depicting pair operations (pair split/pair resync) for PVOL and SVOL executed by a VOL owner MP-PK. A pair resync operation is to resynchronize the SVOL which is in split state (PSUS) with PVOL, so that the SVOL becomes a copy of the PVOL and continues to be the latest copy of the PVOL.

In step S700, a copy pair owner MP-PK (a VOL owner MP-PK of a PVOL and a corresponding SVOL (referred to as PVOL owner MP-PK) receives pair operation command.

In step S701, the PVOL owner MP-PK extracts VOL numbers of the PVOL and SVOL from the command.

In step S702, the PVOL owner MP-PK extracts pair operation from the command. In this flow chart, this pair operation means either pair split or pair resync operation.

In step S703, the PVOL owner MP-PK looks at the VOL pair information table 2414A and checks if the PVOL and SVOL of the requested pair are in appropriate state for performing the requested operation or not. For example, for a pair split operation the PVOL owner MP-PK checks whether the PVOL and SVOL are in pair state or not. If they are not in pair state, the requested operation cannot be performed. Now if the PVOL and SVOL are not in appropriate state for performing the requested operation, the PVOL owner MP-PK transfers the process to step S704 and returns error to the Host Computer 100 that has issued the command and the program ends.

On the other hand, if it is determined in step S703 that the state of the PVOL and SVOL is good to perform the requested operation, the PVOL owner MP-PK moves the process to step S705.

In step S705, the PVOL owner MP-PK updates the state of the copy pair in the VOL pair information table 2414A to the state that shows that the requested operation is in progress. For example, if the operation is “pair create”, status is changed to COPY(PD), which means that initial copy is in progress. If the operation is “pair split”, status becomes COPY(SP), which means that differential copy from Sub-PVOL to Sub-S VOL is in progress. If the operation is “pair resync”, status goes to COPY(RS), which means that the differential copy from Sub-PVOL to Sub-SVOL is in progress.

In step S706, the PVOL owner MP-PK looks at the Sub-VOL owner MP-PK table 2412A and gets the information about the Sub-VOL owner MP-PKs of the PVOL and the SVOL. Then, the PVOL owner MP-PK requests each of those Sub-VOL owner MP-PKs to perform the requested operation on their owned Sub-VOL pair. The detailed processing of step S706 is shown in FIG. 20 and is explained later.

In step S707, the PVOL owner MP-PK waits for the completion of the requested task in the previous step. After getting the acknowledgement from all Sub-VOL owner MP-PKs, the PVOL owner MP-PK moves the process to step S708 and it updates the status of the VOL pair according the requested operation. For example, if the requested operation is a pair split operation, the PVOL owner MP-PK updates the pair state to “PSUS”.

In step S709, the PVOL owner MP-PK returns acknowledgement about completion of the requested operation to the Host Computer 100 that has issued the command and the program ends.

<Pair Operations (Pair Split, Pair Resync and Pair Create) for Sub-PVOL and Sub-SVOL>

FIG. 20 is a flowchart depicting pair operations (e.g. pair split/pair resync/pair create) for Sub-PVOL and Sub-SVOL executed by a Sub-VOL owner MP-PK. These pair operations correspond to the processing in step S608 in FIG. 18. So, any pair operation is first partly executed by the owner MP-PK (PVOL owner MP-PK) of the target copy pair VOLs, as described in S608 of FIG. 18. The owner MP-PK of the target copy pair VOL then asks each Sub-VOL owner MP-PK of the target copy pair VOLs to perform their part of the requested task. Once a Sub-VOL owner MP-PK performs the requested operation, it acknowledges the VOL owner MP-PK about the completion of the task. When all the Sub-VOL owner MP-PKs acknowledge about completion of the task, the owner of copy pair VOLs perform the final tasks for the requested operation and the program ends. An example of such process is explained by the flowchart in FIG. 20.

In step S800, the Sub-VOL owner MP-PK receives a command of a pair operation from the PVOL owner MP-PK. In this example, the pair operations can be pair create, pair split or pair resync.

In step S801, the Sub-VOL owner MP-PK extracts the VOL numbers of the PVOL and SVOL from the command.
In step S802, the Sub-VOL owner MP-PK extracts the pair operation.
In step S803, the Sub-VOL owner MP-PK looks at the Sub-VOL pair information table 2222A and checks if the Sub-PVOL and Sub-SVOL of the requested pair are in appropriate state for performing the requested operation or not as explained S703. If the Sub-PVOL and Sub-SVOL are not in appropriate state for performing the requested operation, the Sub-VOL owner MP-PK transfers the process to step S804 and returns an error notice to the VOL owner MP-PK (the PVOL owner MP-PK which is executing the processing of FIG. 18) and the program ends.

On the other hand, if it is determined in step S803 that the state of the Sub-PVOL and Sub-SVOL is good to perform the requested operation, the Sub-VOL owner MP-PK moves the process to step S805.

In step S805, the Sub-VOL owner MP-PK updates the status of the copy pair in the Sub-VOL pair information table 2222A to the status that shows that the requested operation is in progress as explained in S708.

In step S806, the Sub-VOL owner MP-PK performs the action according to the requested operation. Actions for the three examples of pair operations are as follows. In case where the requested operation is “pair resync”, the Sub-VOL owner MP-PK reads the differential bitmap from the Sub-VOL pair information table 2222A and updates Sub-SVOL according to the differential bitmap, so that it becomes an exact copy of the current Sub-PVOL. In case where the requested operation is pair split, the Sub-VOL owner MP-PK triggers the asynchronous copy process which again reads the differential bitmap from the Sub-VOL pair information table 2222A and updates Sub-SVOL according to the differential bitmap, so that it becomes an exact copy of the current Sub-PVOL. In case where the requested operation is pair create, the Sub-VOL owner MP-PK performs the initial copy operation on the Sub-SVOL, it becomes an exact copy of the current Sub-PVOL. As it can be observed that all three operations stated above essentially perform a copy operation on Sub-S VOL so that it becomes an exact copy of the Sub-SVOL. Thus these three operations can be performed by a single sub-program which can be triggered at different occasions.

In step S807, the Sub-VOL owner MP-PK updates the state of the Sub-VOL pair in the Sub-VOL information table, according the requested operation. For example, if the requested operation is a pair split operation, the Sub-VOL owner MP-PK updates the Sub-VOL pair state to “PSUS”.

In step S808, the Sub-VOL owner MP-PK returns acknowledgement to the VOL owner MP-PK about completion of the requested operation and the program ends.

### <PVOL Write Operation>

FIG. 21 is a flowchart depicting PVOL write operation executed by a Sub-VOL owner MP-PK, Any PVOL write command is directed to the MP-PK which possesses ownership of the Sub-VOL that contains the target address range for write operation as in the case of Simplex VOLs in embodiment 1.

Steps S900 to S906 are the same as the steps S400 to S406 of FIG. 12 in the embodiment 1, except for the fact that the tables, to which the Sub-VOL owner MP-PK refers, are the tables for this embodiment.

In step S907, the Sub-VOL owner MP-PK reads the Sub-VOL pair information table 2222A and checks if the Sub-VOL has a copy-pair Sub-VOL (Sub-SVOL) or not. If there is no Sub-SVOL for the target Sub-PVOL, the Sub-VOL owner MP-PK moves the process to step S909. On the other hand, if there is a Sub-SVOL, the Sub-VOL owner MP-PK moves the process to step S908 and updates the differential bitmap for the Sub-VOL pair in the Sub-VOL pair information table 2222A.

In step S909, the Sub-VOL owner MP-PK returns “GOOD” to the Host Computer 100 and the program ends.

The de-staging of this data from the data receive buffer to the disk drives 251 is performed by a different program. This data de-staging process is widely known and is not described in this context.

In this invention, the owner authorities of original (PVOL) and copy (SVOL) volumes of copy functions are assigned to the same processor that improves the performance of copy functions (PP), Furthermore, PVOL and SVOL divided into a plurality of the sub-volumes (primary sub-volumes and secondary sub-volumes), respectively and the same processor is assigned to the corresponding primary sub-volume and secondary sub-volume. Now, since there can be multiple SVOLs for a PVOL, the cumulative load caused by PVOL and SVOL may become very large. With this invention the load is distributed evenly for a better utilization of MPPKs.

### (3) Embodiment 3

This embodiment relates to a method to implement a VOL copy function named Snapshot using Sub-VOLs.

Snapshot VOL copy technique makes a point-in-time copy of a PVOL that takes less than or equal to the space required by the PVOL. The Snapshot SVOL is a virtual VOL whose data is either the same physical data of PVOL or is stored in a different VOL named Pool VOL or partly in both. When a Snapshot VOL is created, a table namely Logical Block Address (or some other unit) Pointer table keeps track about where the data of the SVOL is stored. If the Snapshot copy pair VOLs are in pair state means the SVOL data should be the same as PVOL data, then each of the Logical Block Address (hereinafter abbreviated as LBA) Pointers for SVOL point to the PVOL's LBA. And if the Snapshot copy pair is in Split state (PSUS), the SVOL should keep data of PVOL at the time when Split operation was performed. To achieve this goal, a Pool. VOL is used to keep all the original data of PVOL that gets changed, since the pair split operation was performed. Also the LBA pointer for the Pool VOL where the data of PVOL was saved is maintained in a table called LBA data pointer table 2223B. Now, in this embodiment, the above mentioned Snapshot copy function is implemented using Sub-VOLs. To achieve this, the LBA Data Pointer tables 2223B are made for each Sub-VOL. As in case of embodiment 2, in this embodiment also, the owner of primary VOL and secondary VOL (copy VOL) are made to be the same. Also the owner of each of primary Sub-VOLs and the corresponding secondary Sub-VOLs (copy Sub-VOL) are made to be the same respectively. Detailed explanation of the method follows.

### <Structure of Cache Memory Package>

The structure of cache memory package (CM-PK) 240 for this embodiment is substantially the same as the one shown in FIG. 14, except for using VOL pair information table instead of the VOL pair information table 2414A in FIG. 14. The VOL pair information table keeps the information about Snapshot copy VOL pairs. The status field of the table keeps information about the status of the snapshot copy pair. The status field can have the value “PAIR”, if the snapshot copy pair VOLs are in pair state and the contents of PVOL are the same as contents of SVOL; the value “COPY(PD)”, if a new pair is created and the processing (e.g. making a pool VOL etc) is underway before actually achieving the pair state, also this state does not perform initial copy operation as in the case of copy-pair's “COPY(PD)” state; the value “PSUS”, if the VOL pair is in split state and the SVOL should keep the data of PVOL of the time when pair split operation is performed.

### <Regarding Each Program in Program Memory>

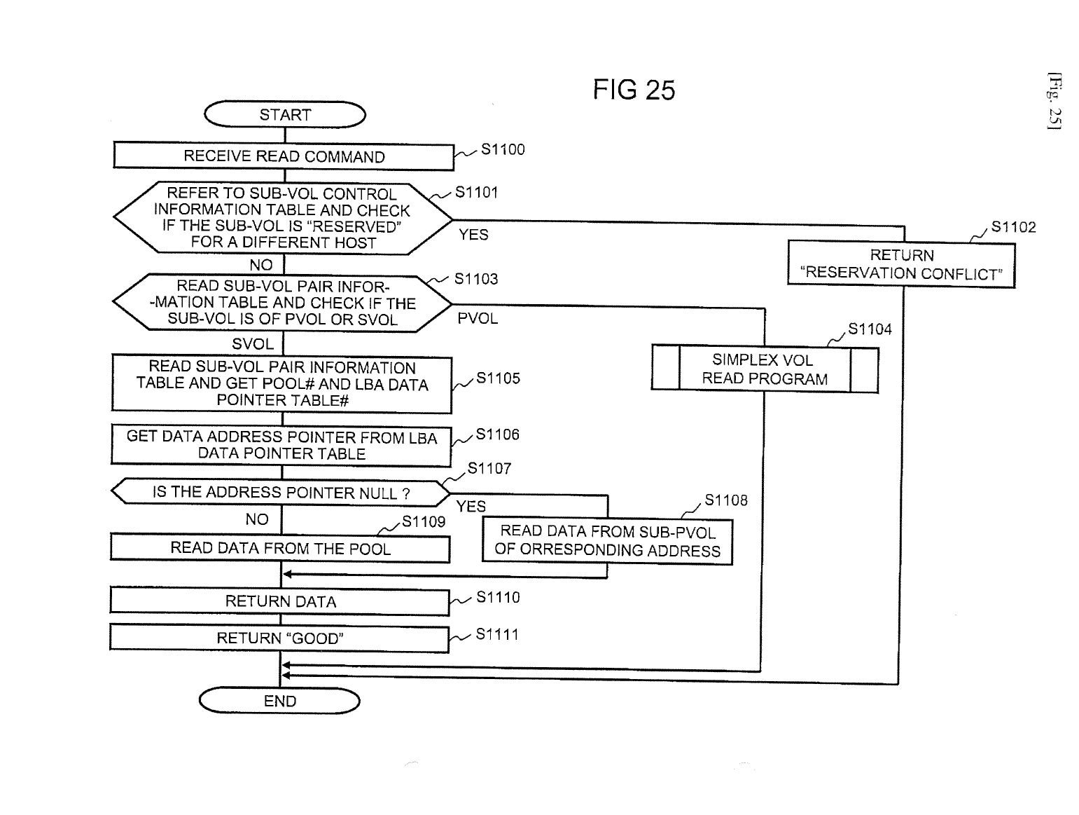

The programs in the program memory are as shown in FIG. 14. The VOL creation program 2421A is used to make new VOLs (PVOL and SVOL). For PVOL, it is same as program 2421 used in the embodiment 1 as depicted in FIG. 9. Also, for SVOL, it is same as program 2421 except for the fact that since SVOL is a virtual VOL, step S101 and step S103 in FIG. 9 are skipped because the snapshot SVOL does not require physical space at the time it is created.
The read request processing program 2422A, in this embodiment, is used to process the read operation related commands. The flowchart of this program is shown in FIG. 25 and will be explained later.

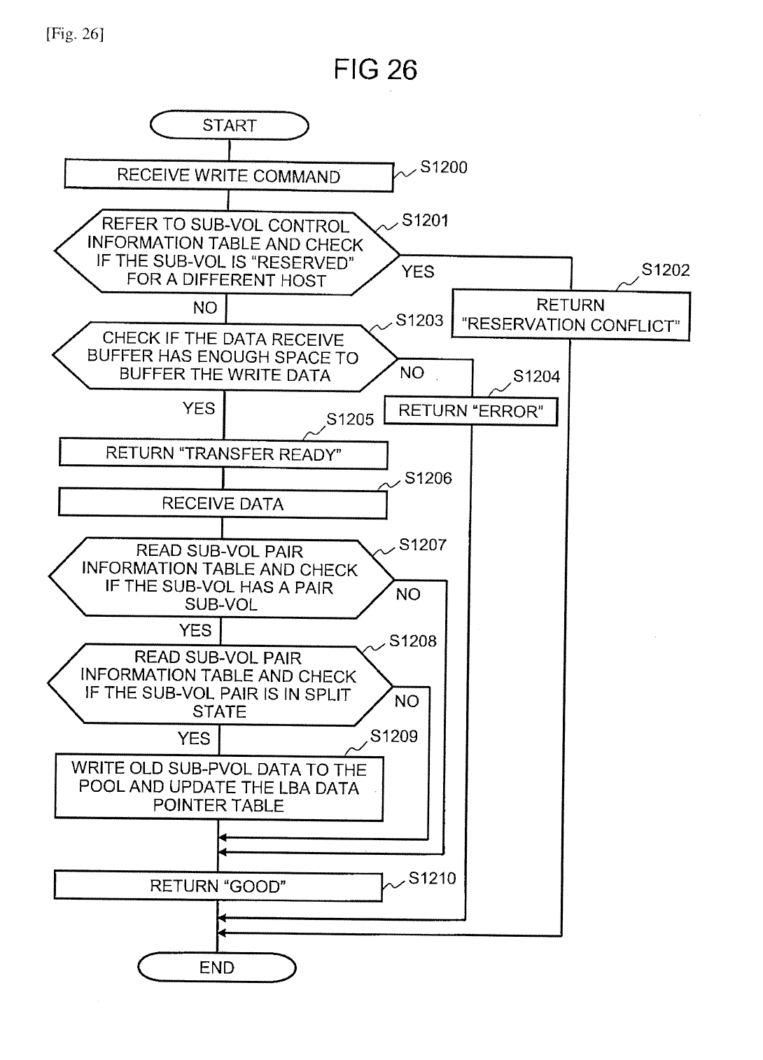

The PVOL write request processing program 2423A, in this embodiment, is used to process the write operation related commands. The flowchart this program is shown in FIG. 26 and will be explained later.

The pair create program 2427A, in this embodiment, is used to create Snapshot copy pair. The flow of the program is the same as pair create program shown in FIG. 18 except for the fact that the VOL pair information table used in step S606, step S607, step S610 uses information of the Snapshot copy VOL pairs. Also in step S608 initial copy operation is not performed on the Sub-VOL pairs, instead a Pool-VOL is created and assigned or an existing one is assigned, to each of the Sub-VOL pairs by their corresponding Sub-VOL pair owner MP-PK.

The pair operation program for VOL owner MP-PK 2428A performs Snapshot copy pair related operations such as pair split/pair resync etc as explained in embodiment 2.

Pair operation program for Sub-VOL owner MP-PK 2429A, in this embodiment, refers to the Sub-VOL pair information table 2222B in step S805, step S806 and step S807 in FIG. 20, instead of the Sub-VOL pair information table 2222A. An example of table 2222B is shown in FIG. 23 and is explained later.

In step S806, in this embodiment, while updating the Sub-VOL pair information table 2222B for a given pair operation, the corresponding Pool number and LBA data pointer table number are updated, and the contents of corresponding LBA data pointer table is also updated as per the requirement of the operation. For example, if the operation is “pair create,” a new LBA data pointer table 2223B is created for the pair, a Pool VOL is assigned for the Sub-VOL pair and a new entry is added to the Sub-VOL pair information table 2222B with the target Sub-PVOL ID, target Sub-SVOL ID, assigned Pool VOL number and the created LBA pointer address table number. If the operation is “pair split”, in step S806 only status is changed in the Sub-VOL pair information table 2222B. If the operation is “pair resync”, in step S806, the LBA data pointer table 2223B is filled with ‘NULL’, representing that all the Sub-SVOL's data is the same as the current Sub-PVOL.

<Structure of Memory in FE-PK>

The structure of memory 213 in FE-PK 210 in this embodiment is the same as in the embodiment 1. VOL owner MP-PK table 2131 and Sub-VOL owner MP-PK table 2132 are also used in this embodiment for the same purpose.

The LR processing program 2133 of the embodiment 1 is also used in this embodiment for the same purpose, and additionally it also forwards the Snapshot copy pair related commands to VOL (PVOL/SVOL pair) owner MP-PK.

As shown in the example flow of the LR processing program in FIG. 10, in step S202, commands other than the VOL (PVOL or SVOL) read/write commands (these other commands also include Snapshot copy pair related commands) are forwarded to VOL (PVOL/SVOL) owner MP-PK via steps S206 to S208 in FIG. 10.

<Structure of Local Memory in MP-PK>

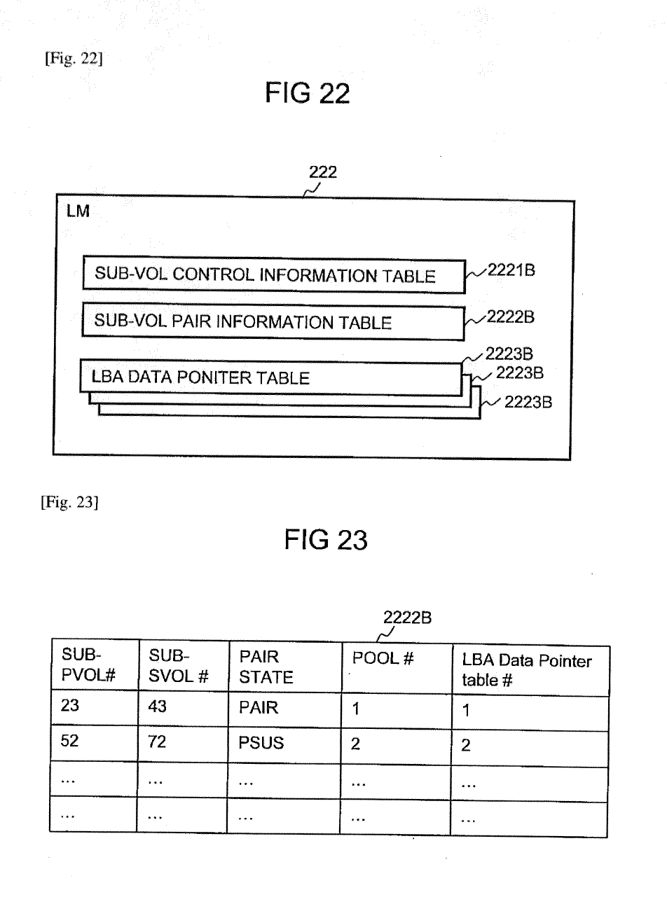

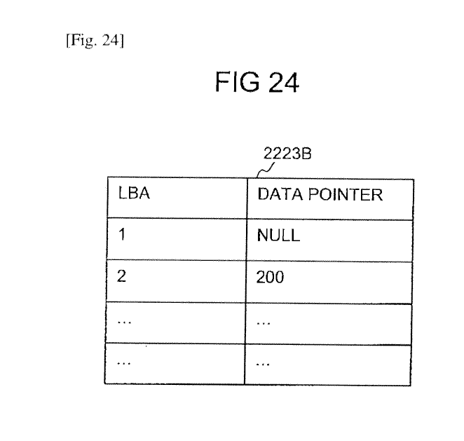

FIG. 22 shows an example of the contents of LM 222 in MP-PK 220. It consists of a Sub-VOL control information table 2221B, a Sub-VOL pair information table 2222B and a plurality of LBA Data Pointer tables 2223B.
The Sub-VOL control information table 222113 is the same as Sub-VOL control information table 2221 of the embodiment 1.
The Sub-VOL pair information table 2222B contains information about Sub-VOL pair. An example of this table is given in FIG. 23 and will be explained later.
The example of the LBA Data Pointer table 2223B is provided in FIG. 24.

### <Structure of VOL Pair Information Table>

The VOL pair information table for this embodiment is the same as table 2414A, except for the fact that it keeps the pair information about the Snapshot copy VOL pairs, instead of the Shadow Image copy VOL pairs.

### <Structure of Sub-VOL Pair Information Table>

FIG. 23 shows an example of Sub-VOL pair information table 2222B. This table is the same as table 2222A except that it has two additional fields and does not have the bitmap field. One additional field is ‘Pool number’ and the other is ‘LBA Data Pointer table (2223B) number’. The Pool number shows the number of a Pool VOL associated with the corresponding Snapshot Copy pair Sub-VOLs. The LBA Data Pointer table 2223B keeps tracks of address pointers of the data of the corresponding Sub-SVOL. An example of the LBA Data Pointer table is shown in FIG. 24.

### <Structure of LBA Data Pointer Table>

FIG. 24 shows an example of one of LBA Data Pointer tables 2223B provided in LM 222. For each Snapshot copy VOL pair, there is a corresponding LBA Data Pointer table 2223B.
The LBA Data Pointer 2223B consists of a ‘LBA’ field and a ‘Data Pointer’ field. The LBA field is Logical Block Address (hereinafter abbreviated as LBA) of a Sub-SVOL to which the table is associated with. The ‘Data Pointer’ field is an address pointer for the data of the corresponding LBA of Sub-SVOL. If this field is ‘NULL’, it means the Sub-SVOL data is the same as the Sub-PVOL data and should be read from the same LBA of the Sub-PVOL. If the field is not ‘NULL’, the field's value is the address of the corresponding Pool VOL where the Sub-SVOL's data is located.

### <Read Operation for PVOL and SVOL>

FIG. 25 is a flowchart depicting PVOL/SVOL read operation executed by the Sub-VOL owner MP-PK.

In step S1100, the Sub-VOL owner MP-PK receives a read command sent from a Host Computer 100.

The step S1101 corresponds to the step 301. If there is any reservation conflict, the process goes to the step S1102 and the program ends. On the other hand, if the Sub-VOL is either “RELEASED” or the “RESERVED” for the same Host Computer 100 which sent this read command, then the Sub-VOL owner MP-PK moves the process to step S1103.

In step S1103, the Sub-VOL owner MP-PK reads the Sub-VOL control information table 2221B and checks whether the target Sub-VOL is a Sub-PVOL or Sub-SVOL. If the target Sub-VOL is a Sub-PVOL, the Sub-VOL owner MP-PK moves the process to step S1104 and executes the Simplex VOL read operation from step S303 of FIG. 11 in the embodiment 1.

In step S1103, if the target Sub-VOL is a Sub-SVOL, the Sub-VOL owner MP-PK moves the process to step S1105 and, in step S1105, reads the Sub-VOL pair information table 2222B and gets the information of the Pool number and the corresponding LBA Data Pointer table number.

In step S1106, the Sub-VOL owner MP-PK reads the relevant LBA Data Pointer table 2223B, and gets the addresses of the target LBAs.

In step S1107, the Sub-VOL owner MP-PK checks whether the pointer field is ‘NULL’ or not. If it is ‘NULL’, the Sub-VOL owner MP-PK moves the process to step S1108 and reads data from the target pair's Sub-PVOL's corresponding LBA. On the other hand, if it is determined in step S1107 that the Data Pointer field has some value other than ‘NULL’, the Sub-VOL owner MP-PK treats it as the address of the corresponding Pool VOL and, in step S1109, it reads the data from the corresponding Pool VOL.

After reading the data either via step S1108 or step S1109, the Sub-VOL owner MP-PK moves the process to step S1110 and returns the read data. In step S1111, the Sub-VOL owner MP-PK returns “GOOD” and the program ends.

<Write Operation for PVOL>

FIG. 26 is a flowchart depicting the PVOL write operation executed by a Sub-VOL owner MP-PK. This flowchart is the same as the flowchart shown in FIG. 21 except for a few facts explained in this paragraph.

The Steps S1200 to S1207 in FIG. 26 are the same as steps S900 to S907 of FIG. 21. The Sub-VOL pair information table referred in step S1207 is table 2222B. In step S1208 the Sub-VOL owner MP-PK checks whether the Snapshot Sub-VOL pair is in Split state (PSUS) or not. If it is not in the Split state, the Sub-VOL owner MP-PK transfers the process to step S1210. If the Snapshot Sub-VOL pair is in the Split state, the Sub-VOL owner MP-PK moves the process to step S1209 and before the buffered data is destaged to the Sub-PVOL the Sub-VOL owner MP-PK reads PVOL data and writes it to the corresponding Pool VOL. Also, the Sub-VOL owner MP-PK updates the LBA data pointer table 2223B with the address of Pool VOL where the MP-PK wrote the data.

In step 1210 the Sub-VOL owner MP-PK returns “GOOD” to the Host Computer which issued the write command and the program ends.

### (4) Other Notes

The present invention can also be realized by a program code of software for realizing the functions of the embodiments. In this case, a storage medium having recorded therein the program code is provided to a system or an apparatus and a computer (or a CPU or an MPU) of the system or the apparatus reads out the program code stored in the storage medium. In this case, the program code itself read out from the storage medium realizes the functions of the embodiments explained above. The program code itself and the storage medium having the program code stored therein configure the present invention. As the storage medium for supplying such a program code, for example, a flexible disk, a CD-ROM, a DVD-ROM, a hard disk, an optical disk, a magneto-optical disk, a CD-R, a magnetic tape, a nonvolatile memory card, or a ROM is used.

Moreover, it is also possible that the program code of the software for realizing the functions of the embodiments is delivered via a network, whereby the program code is stored in storing means such as a hard disk or a memory of a system or an apparatus or a storage medium such as a CD-RW or a CD-R and, when the program code is used, a computer (or a CPU or an MPU) of the system or the apparatus reads out and executes the program code stored in the storing means or the storage medium.

Lastly, it is necessary to understand that the process and the technique explained above are not essentially related to any specific apparatus and can be implemented by any appropriate combination of components. Further, it is possible to use general-purpose devices of various types according to the teaching explained above. It may be seen that it is useful to build a dedicated apparatus to execute the steps of the method explained above. Various inventions can be formed by an appropriate combination of the plural components disclosed in the embodiments. For example, several components may be deleted from all the components explained in the embodiments. Further, the components explained in the different embodiments may be combined as appropriate. The present invention is described in relation to the specific examples. However, the specific examples are for explanation and are not for limitation in every aspect. It would be understood by those skilled in the art that there are a large number of combinations of hardware, software, and firmware suitable for carrying out the present invention. For example, the software explained above can be implemented in a program or a script language in a wide range such as assembler, C/C++, perl, Shell, PHP, and Java (registered trademark).

Further, in the embodiments, control lines and information lines considered necessary in explanation are shown. Not all control lines and information lines are shown in terms of a product. All components may be coupled to one another.

In addition, other implementations of the present invention would be made apparent for those having ordinary knowledge in the technical field from the examination of the specification and the embodiments of the present invention disclosed herein. The various forms and/or components of the explained embodiments can be used independently or in any combination in a computerized storage system having a function of managing data. The specification and the specific examples are merely typical ones. The scope and the spirit of the present invention are indicated by the following claims.

### REFERENCE SIGNS LIST

100 Host Computer
200 Storage subsystem
210 Front End Package (FE-PK)
212 Local Router (LR)
213 Memory
220 MicroProcessor Package (MP-PK)
221 MicroProcessor (MP)
222 Local Memory (LM)
230 Back End Package (BE-PK)
240 Cache Memory Package (CM-PK)
241 Shared Memory (SM)
242 Program memory
243 Cache memory
250 Disk unit
251 Disk drive
300 Management computer
400 Local Area Network (LAN)
500 Storage Area Network (SAN)

1. A computer system coupled to a computer comprising:
a storage subsystem including a plurality of storage devices providing at least one logical volume to the computer and a plurality of processor units each of which processes a command issued by the computer;
wherein at least one of the logical volumes is divided into a plurality of sub-volumes,
wherein a volume owner processor of the logical volume, which is responsible for processing I/O for the logical volume, is one of the plurality of processor units, and a sub-volume owner processor for the at least one of the plurality of sub-volumes is one of the plurality of processor units which is not the volume owner processor of the logical volume.

2. A computer system according to claim 1, wherein the storage subsystem further includes a processor unit which analyzes a type of a command from the computer in order to forward the command either to the sub-volume owner processor unit or to the volume owner processor unit.

3. A computer system according to claim 1, wherein each of the sub-volume owner processor unit processes a read or write command for the responsible sub-volume, and the volume owner processor unit processes commands other than the read and write commands for the responsible logical volume.

4. A computer system according to the claim 3,
wherein the commands other than the read and write commands includes a reserve or release command for the responsible logical volume.

5. A computer system according to claim 1, wherein a processor unit, in response to a request of logical volume creation received, determines a number of the sub-volumes in the logical volume to be created, the volume owner processor unit for the logical volume to be created and the sub-volume owner processor units for each of the sub-volumes to be defined in the logical volume to be created.

6. A computer system according to claim 5, wherein the processor unit which handles the request of logical volume creation divides the logical volume by the number of the plurality of processor units to define the sub-volumes in the logical volume to be created.

7. A computer system according to claim 5, wherein the processor unit which handles the request of logical volume creation divides the logical volume based on a predetermined sub-volume size to define the sub-volumes in the logical volume to be created.

8. A computer system according to claim 1, wherein a processor unit acquires information of utilization rate of each processor unit and changes the ownership of at least one the sub-volumes of the logical volume based on the information of utilization rate.

9. A computer system according to claim 2, wherein the storage subsystem further includes at least one frond end unit, and the processor which analyzes a type of the command is provided as a local router in the front end unit.

10. A computer system according to claim 1,
wherein the at least one of the logical volumes includes a first logical volume and a second logical volume;
wherein the first logical volume is paired up as copy pair with the second logical volume,
the volume owner processor unit is in common between the first and second logical volumes, and,
the sub-volume owner processor units are in common among each of the corresponding sub-volumes in the first and second logical volumes.

11. A computer system according to claim 10, wherein the second logical volume is a logical volume which stores replication data of data stored in the first logical volume or a virtual volume whose storage area is mapped either to a corresponding storage area in the first logical volume or a storage area in a pool volume.

12. A computer system according to claim 10,
wherein the command from the computer is forwarded to either the volume owner processor unit of the first and second logical volumes or one of the sub-volume owner processor units of the each sub-volume in the first and second logical volumes based on a kind of the command.

13. A computer system according to claim 12, wherein the command forwarded to the volume owner processor unit of the first and second logical volumes includes split or resynchronization command for the pair of the first and the second logical volumes.

14. A computer system according to claim 1, wherein each processor unit comprises a plurality of microprocessors,
wherein the volume owner processor of the logical volume and the sub-volume owner processors are assigned to the plurality of microprocessors instead of the processor units.

15. A computer system according to claim 14, wherein the each processor unit further comprises a local memory, which is accessed by the at least one core processor.

16. A volume management method for a computer system coupled to a computer comprising a storage subsystem including a plurality of storage devices providing at least one logical volume to the computer and a plurality of processor units each of which processes a command issued by the computer; the method comprising the steps of:
one of the processor units dividing a logical volume into a plurality of sub-volumes;
one of the processor units determining one of the plurality of processor units as a volume owner processor of the logical volume, which is responsible for processing I/O for the logical volume; and,
one of the processor units determining another one of the plurality of processor units as a sub-volume owner processor for at least one of the plurality of sub-volumes.

17. A volume management method according to claim 16, further comprising the steps of:
one of the plurality of processor units analyzing a type of a command from the computer in order to forward the command either to the sub-volume owner processor unit or to the volume owner processor unit.

18. A volume management method according to claim 16, wherein each of the sub-volume owner processor unit processes a read or write command for the responsible sub-volume, and the volume owner processor unit processes commands other than the read and write commands for the responsible logical volume.

19. A volume management method according to claim 16, further comprising the steps of:
one of the plurality of processor units acquiring information of utilization rate of each processor unit; and,
one of the plurality of processor units changing the ownership of at least one the sub-volumes of the logical volume based on the information of utilization rate.

20. A volume management method according to claim 16, wherein
the at least one of the logical volumes includes a first logical volume and a second logical volume;
wherein the first logical volume is paired up as copy pair with the second logical volume,
the volume owner processor unit is in common between the first and second logical volumes, and,
the sub-volume owner processor units are in common among each of the corresponding sub-volumes in the first and second logical volumes.
